(19) United States
(12) Patent Application Publication
(10) Pub. No.: US 2026/0010861 A1
(43) Pub. Date: Jan. 8, 2026

(54) Systems and Methods of Reverse Logistics Without Packaging and Labelling

(71) Applicant: Blue Yonder Group, Inc., Scottsdale, AZ (US)

(72) Inventors: Peter Edward Stubbs, Georgetown, MA (US); Raghuveer Prasad Nagar, Kota (IN)

(21) Appl. No.: 19/225,520

(22) Filed: Jun. 2, 2025

Related U.S. Application Data
(60) Provisional application No. 63/668,635, filed on Jul. 8, 2024.
(60) Provisional application No. 63/675,127, filed on Jul. 24, 2024.

(51) Int. Cl. G06Q 10/083; H04L 9/40

(52) U.S. Cl. CPC G06Q 10/083; H04L 63/0846

(57) ABSTRACT

A system and method are disclosed for planning a return of ordered products without packaging and labelling. The method further includes identifying product returns that do not require packaging and labelling, generating a return collection plan indicating the product returns to be received and picked up, wherein the product returns do not require packaging for transport by the returns pickup vehicle, communicating the return collection plan to collection resources, generating a loading plan for the product returns, communicating the loading plan for a collection resource to access and follow in loading the product returns on the returns pickup vehicle, generating an inbound staging plan for the product returns, and communicating the inbound staging plan to receiving resources.

### CROSS-REFERENCE TO RELATED APPLICATIONS

The present disclosure is related to that disclosed in the U.S. Provisional Application No. 63/668,635, filed Jul. 8, 2024, entitled “Zero Packaging Shipping,” and U.S. Provisional Application No. 63/675, 127, filed Jul. 24, 2024, entitled “Reverse Logistics Without Packaging and Labelling.” U.S. Provisional Application Nos. 63/668,635 and 63/675,127 are assigned to the assignee of the present application. The present invention hereby claims priority under 35 U.S.C. § 119 (e) to U.S. Provisional Application Nos. 63/668,635 and 63/675,127.

### TECHNICAL FIELD

The present disclosure relates generally to reverse logistics and more specifically to reverse logistics for zero packaging returns.

### BACKGROUND

An important aspect of e-commerce and omni-channel commerce is parcel shipment during product returns. Generally, enterprises receive product returns that include packaging materials, such as boxes, bags, wrappers, packing materials, and shipping labels. Current reverse logistics systems require large volumes of packaging materials to successfully and accurately complete product returns. However, such use of large volumes of packaging materials during reverse logistics processes requires disposal or recycling and results in waste or energy expenditures that are not environmentally sustainable and may be inconvenient for customers and enterprises to deal with. Further, using large volumes of packaging materials also lead to high costs of shipping, unloading, and staging. Current reverse logistics systems thus result in increased overhead, decreased customer satisfaction, and decreased sustainability, all of which are undesirable.

### BRIEF DESCRIPTION OF THE DRAWINGS

A more complete understanding of the present invention may be derived by referring to the detailed description when considered in connection with the following illustrative figures. In the figures, like reference numbers refer to like elements or acts throughout the figures.

FIG. 1 illustrates a supply chain network, in accordance with a first embodiment;

FIG. 2 illustrates the zero packaging reverse logistics system, the archiving system, and the planning and execution system of FIG. 1 in greater detail, as well as a home automation system and a mobile device, in accordance with an embodiment;

FIG. 3 illustrates a method for planning a return of ordered products without packaging and labelling;

FIG. 4 illustrates a method for collecting unpackaged product return privately and securely, in accordance with an embodiment;

FIG. 5 illustrates a method for facilitating a return of one or more products without packaging, in accordance with an embodiment; and

FIG. 6 illustrates a method for facilitating a return of one or more products without packaging with a promotion, in accordance with an embodiment.

### DETAILED DESCRIPTION

Aspects and applications of the invention presented herein are described below in the drawings and detailed description of the invention. Unless specifically noted, it is intended that the words and phrases in the specification and the claims be given their plain, ordinary, and accustomed meaning to those of ordinary skill in the applicable arts.

In the following description, and for the purposes of explanation, numerous specific details are set forth in order to provide a thorough understanding of the various aspects of the invention. It will be understood, however, by those skilled in the relevant arts, that the present invention may be practiced without these specific details. In other instances, known structures and devices are illustrated or discussed more generally in order to avoid obscuring the invention. In many cases, a description of the operation is sufficient to enable one to implement the various forms of the invention, particularly when the operation is to be implemented in software. It should be noted that there are many different and alternative configurations, devices and technologies to which the disclosed inventions may be applied. The full scope of the inventions is not limited to the examples that are described below.

As described in further detail below, embodiments of the following disclosure provide systems and methods for zero packaging reverse logistics for customers of an omni-channel retail system, which may be offered as a return option as part of a supply chain or supply chain network. Embodiments determine one or more product returns that may be performed without additional packaging or labelling and generate reverse logistics plans, such as a return collection plan for the one or more product returns, a loading plan for the one or more product returns, and an inbound staging plan for the one or more product returns. Systems and methods disclosed herein may further communicate the reverse logistics plans with collection resources and/or receiving resources.

Embodiments of the following disclosure provide for secure collection of product returns without the use of additional packaging materials, such as boxes, bags, packing materials, and shipping labels. Embodiments further generate a personalized promotion to incentivize and/or reward a customer for selecting a zero packaging reverse logistics option for one or more product returns. Systems and methods disclosed herein may also provide subscriptions to customers for zero packaging reverse logistics for one or more product returns. In addition, embodiments provide deep-learning techniques for image recognition of one or more product returns at a pickup location and temporal authentication credentials to a home automation system for physical access for a pickup of one or more product returns.

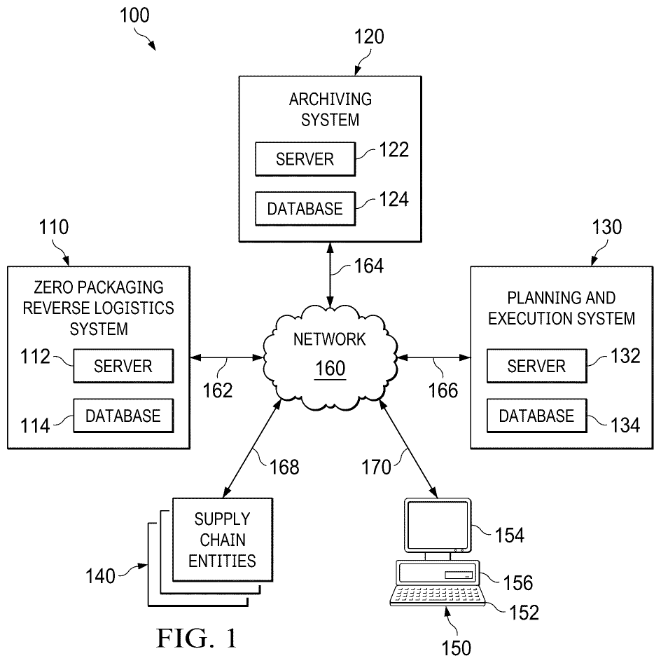

FIG. 1 illustrates supply chain network 100, in accordance with a first embodiment. Supply chain network 100 comprises zero packaging reverse logistics system 110, archiving system 120, planning and execution system 130, one or more supply chain entities 140, one or more computers 150, network 160, and one or more communication links 162-170. Although a single zero packaging reverse logistics system 110, a single archiving system 120, a single planning and execution system 130, one or more supply chain entities 140, one or more computers 150, a single network 160, and one or more communication links 162-170 are illustrated and described, embodiments contemplate any number of zero packaging reverse logistics systems, archiving systems, planning and execution systems, supply chain entities, computers, networks, or communication links, according to particular needs.

In one embodiment, zero packaging reverse logistics system 110 comprises server 112 and database 114. Although zero packaging reverse logistics system 110 is illustrated in FIG. 1 as comprising a single server 112 and a single database 114, embodiments contemplate zero packaging reverse logistics system 110 including any suitable number of servers, databases, serverless computing options, or data stores internal to, or externally coupled with, zero packaging reverse logistics system 110, according to particular needs. For the purposes of this disclosure, all instances of “server” are understood to include, according to embodiments, one or more embodiments of servers, serverless computing options, and/or other computing solutions, and all instances of “database” are understood to include, according to embodiments, databases, datastores, data stores, and/or other data storage systems, according to particular needs. In embodiments, zero packaging reverse logistics system 110 provides zero packaging shipping to customers of supply chain network 100, such as customers of particular retailer or e-commerce platform within supply chain network 100. As used herein, the word “customer” includes individual shoppers or consumers (including humans and automated machines or bots), business or organizational clients, or any other person, machine, or entity that may place an order for goods or services and/or request a return of one or more products. As described in further detail below, to provide zero packaging reverse logistics, zero packaging reverse logistics system 110 may determine one or more product returns that do not require packaging and labelling. Zero packaging reverse logistics system 110 may further generate a return collection plan and communicate the return collection plan to one or more collection resources to collect the one or more product returns. In embodiments, zero packaging reverse logistics system 110 also generates a loading plan and communicates the loading plan to the one or more collection resources, as well as an inbound staging plan for one or more product returns and communicates the inbound staging plan to one or more receiving resources. Embodiments contemplate the one or more collection resources providing authentication to a home automation system to provide physical access to the one or more collection resources for the pickup of one or more product returns. Embodiments further contemplate zero packaging reverse logistics system 110 providing a personalized promotion for a customer utilizing zero packaging reverse logistics. According to some embodiments, zero packaging reverse logistics system 110 generates a one-time-password for a password protected entrance door to a collection resource, such as, for example, a part of a message to enter the entrance door. In other embodiments, zero packaging reverse logistics system 110 enables a drone collection resource to be provided access to a geographical location, such as a window or other location, for a particular period of time, wherein a home automation system may detect the collection resource using image analysis and report back to the customer and/or premise-owner over the internet and/or via network 160.

Archiving system 120 comprises server 122 and database 124. Although archiving system 120 is illustrated as comprising a single server 122 and a single database 124, embodiments contemplate any suitable number of servers or databases internal to, or externally coupled with, archiving system 120. Server 122 of archiving system 120 may support one or more processes for receiving and storing data from planning and execution system 130 and/or one or more computers 150 of supply chain network 100. According to some embodiments, archiving system 120 comprises an archive of data received from planning and execution system 130 and/or one or more computers 150 of supply chain network 100 and provides archived data to zero packaging reverse logistics system 110 and/or planning and execution system 130. Server 122 may store the received data in database 124, which may comprise one or more databases or other data storage arrangements at one or more locations local to, or remote from, server 122.

According to an embodiment, planning and execution system 130 comprises server 132 and database 134. Supply chain planning and execution is typically performed by several distinct and dissimilar processes, including, for example, order promising, assortment planning, demand planning, operations planning, production planning, supply planning, distribution planning, execution, pricing, forecasting, transportation management, warehouse management, inventory management, fulfillment, procurement, reverse logistics, and the like. Server 132 of planning and execution system 130 comprises one or more modules, such as, for example, an order promising module, a sourcing module, a scheduling module, and/or a pick-pack-ship module, for performing one or more order fulfillment processes. Server 132 stores and retrieves data from database 134 or one or more locations in supply chain network 100. In addition, planning and execution system 130 operates on one or more computers 150 that are integral to, or separate from, the hardware and/or software that support archiving system 120 and zero packaging reverse logistics system 110.

One or more supply chain entities 140 may represent one or more customers, suppliers, manufacturers, distribution centers, and multi-channel and/or omni-channel retailers in supply chain network 100, including one or more enterprises. One or more customers may be any entity which places and receives an order for one or more items and/or products, as well as any entity which initiates a product return for one or more items and/or products. One or more customers may further comprise home automation systems which provide a collection resource access through a temporal authentication credential for a pickup to be made for one or more product returns utilizing with zero packaging reverse logistics, as described in further detail below.

One or more suppliers may be any suitable entity that offers to sell or otherwise provides one or more items or components to one or more manufacturers or buyers. One or more suppliers may, for example, receive an item from a first supply chain entity of one or chain entities 140 in supply chain network 100 and provide the item to another supply chain entity of one or more supply chain entities 140, which in some embodiments may be a buyer, a customer, or an end user. Items may comprise, for example, components, materials, products, parts, supplies, or other items that may be used to produce products. In addition, or as an alternative, an item may comprise a supply or resource that is used to manufacture the item but does not become a part of the item. In embodiments, items may comprise a service, such as an installation service. One or more suppliers may comprise automated distribution systems that automatically transport items to one or more manufacturers based, at least in part, on a supply chain plan having fair-shared items or resources, a material or capacity reallocation, current and projected inventory levels, and/or one or more additional factors described herein.

A manufacturer may be any suitable entity that manufactures at least one product. In addition, or as an alternative, a manufacturer may be a suitable entity that repairs, refurbishes, reconditions, remanufactures, and/or services at least one product according to reverse logistics process. A manufacturer may use one or more items during the manufacturing process to produce any manufactured, remanufactured, repaired, refurbished, reconditions, serviced, fabricated, assembled, or otherwise processed item, material, component, good or product. In one embodiment, a product represents an item ready to be supplied to, for example, another supply chain entity of one or more supply chain entities 140, such as a supplier, an item that needs further processing, or any other item. A manufacturer may, for example, produce and sell a product to a supplier, another manufacturer, a distribution center, a retailer, a customer, or any other suitable person or an entity. Such manufacturers may comprise automated robotic production machinery that produce and/or otherwise process products based, at least in part, on a supply chain plan having fair-shared items or resources, a material or capacity reallocation, current and projected inventory levels, and/or one or more additional factors described herein.

One or more distribution centers may be any suitable entity that offers to sell or otherwise distributes at least one product to one or more retailers and/or customers. Distribution centers may, for example, receive a product from a first supply chain entity of one or more supply chain entities 140 in supply chain network 100 and store and transport the product for a second supply chain entity of one or more supply chain entities 140. In addition, or as an alternative, one or more distribution centers may further comprise one or more repair and/or refurbishment depots and/or facilities which provide any kind of servicing, repair, remanufacturing, and/or resale of one or more products returned according to a reverse logistics process. Such distribution centers may comprise automated warehousing systems, delivery vehicles, and/or returns pickup vehicles that automatically transport products to and/or from one or more retailers and/or customers and/or automatically remove an item from, or place an item into, inventory based, at least in part, on a supply chain plan having fair-shared items or resources, a material or capacity reallocation, current and projected inventory levels, and/or one or more additional factors described herein. In embodiments, the one or more distribution centers may comprise different types of resources, for example, humans, automatically guided vehicles (AGVs), robots, and the like.

In an embodiment, one or more distribution centers may comprise any type and/or configuration of one or more vehicles which may provide zero packaging reverse logistics. By way of example only and not by way of limitation, one or more vehicles may comprise different types of vehicles, such as a totally enclosed van, a flatbed truck, and/or a vehicle with racks and/or fixtures. In embodiments, one or more vehicles may comprise one or more capabilities to hold and transport one or more product returns which are being processing with zero packaging reverse logistics. By way of example only and not by way of limitation, a vehicle may comprise padded bins, padded shelving, padded storage, and/or one or more refrigerated compartments to transport one or more product returns with zero packaging reverse logistics. In embodiments, the one or more vehicles may be reconfigured to transport zero packaging reverse logistics pickups depending on requirements for each load, such as, for example, by installing exterior racks and/or containers for a first load and installing padded shelves and padded bins for a second load. According to embodiments, one or more vehicles may comprise one or more collection assets to assist and/or ensure a proper pickup, such as, for example, a detachable backpack and/or detachable receptacle for carrying one or more products, and/or reusable covers and/or containers which provide inclement weather and/or security protection. The one or more collection assets may further comprise reusable lock-enabled boxes and/or containers, which may provide, for example, security for a product return, and may be retrieved from a customer location at a time of a later delivery and/or pickup. Embodiments contemplate that the one or more types of vehicles may comprise autonomous vehicles, such as, for example, self-driving vehicles, robots and/or drones. Embodiments further contemplate that the one or more vehicles may comprise one or more combinations of vehicles, such as multimodal transportation.

One or more retailers may be any suitable entity that obtains one or more products to sell to one or more customers. In addition, one or more retailers may sell, store, and/or supply one or more components. One or more retailers may comprise any online or brick and mortar location, including locations with shelving systems. One or more retailers may further comprise one or more omni-channel retailers. Shelving systems may comprise, for example, various racks, fixtures, brackets, notches, grooves, slots, or other attachment devices for fixing shelves in various configurations. These configurations may comprise shelving with adjustable lengths, heights, and other arrangements, which may be adjusted by an employee of one or more retailers based on computer-generated instructions or automatically by machinery to place products in a desired location.

The same supply chain entity may simultaneously act as any one or more customers, suppliers, manufacturers, distribution centers, and retailers. For example, one or more supply chain entities 140 acting as a manufacturer may produce a product, and the same one or more supply chain entities 140 may act as a supplier to supply a product to another one or more supply chain entities 140. Although one example of supply chain network 100 is illustrated and described, embodiments contemplate any configuration of supply chain network 100 without departing from the scope of the present disclosure.

As illustrated in FIG. 1, supply chain network 100 comprising zero packaging reverse logistics system 110, archiving system 120, planning and execution system 130, and one or more supply chain entities 140 may operate on one or more computers 150 that are integral to, or separate from, the hardware and/or software that support zero packaging reverse logistics system 110, archiving system 120, planning and execution system 130, and one or more supply chain entities 140. One or more computers 150 may include any suitable input device 152, such as a keypad, mouse, touch screen, microphone, or other device to input information. Output device 154 may convey information associated with the operation of supply chain network 100, including digital or analog data, visual information, or audio information. One or more computers 150 may include fixed or removable computer-readable storage media, including a non-transitory computer-readable medium, magnetic computer disks, flash drives, CD-ROM, in-memory device, or other suitable media to receive output from and provide input to supply chain network 100. One or more computers 150 may comprise one or more mobile devices, as discussed in further detail below.

One or more computers 150 may include one or more processors 156 and associated memory to execute instructions and manipulate information according to the operation of supply chain network 100 and any of the methods described herein. In addition, or as an alternative, embodiments contemplate executing the instructions on one or more computers 150 that cause one or more computers 150 to perform functions of the methods. An apparatus implementing special purpose logic circuitry, such as. for example, one or more field-programmable gate arrays (FPGA) or application-specific integrated circuits (ASIC), may perform functions of the methods described herein. Further examples may also include articles of manufacture including tangible non-transitory computer-readable media that have computer-readable instructions encoded thereon, and the instructions may comprise instructions to perform functions of the methods described herein.

In addition, or as an alternative, supply chain network 100 may comprise a cloud-based computing system having processing and storage devices at one or more locations local to, or remote from, zero packaging reverse logistics system 110, archiving system 120, planning and execution system 130, and one or more supply chain entities 140. In addition, each of one or more computers 150 may be a workstation, personal computer (PC), network computer, notebook computer, tablet, personal digital assistant (PDA), cell phone, telephone, smartphone, wireless data port, mobile device, augmented or virtual reality headset, or any other suitable computing device. In an embodiment, one or more users may be associated with zero packaging reverse logistics system 110 and archiving system 120.

In one embodiment, zero packaging reverse logistics system 110 may be coupled with network 160 using communication link 162, which may be any wireline, wireless, or other link suitable to support data communications between zero packaging reverse logistics system 110 and network 160 during operation of supply chain network 100. Archiving system 120 may be coupled with network 160 using communication link 164, which may be any wireline, wireless, or other link suitable to support data communications between archiving system 120 and network 160 during operation of supply chain network 100. Planning and execution system 130 may be coupled with network 160 using communication link 166, which may be any wireline, wireless, or other link suitable to support data communications between planning and execution system 130 and network 160 during operation of supply chain network 100. One or more supply chain entities 140 may be coupled with network 160 using communication link 168, which may be any wireline, wireless, or other link suitable to support data communications between one or more supply chain entities 140 and network 160 during operation of supply chain network 100. One or more computers 150 may be coupled with network 160 using communication link 170, which may be any wireline, wireless, or other link suitable to support data communications between one or more computers 150 and network 160 during operation of supply chain network 100. Although communication links 162-170 are illustrated as generally coupling zero packaging reverse logistics system 110, archiving system 120, planning and execution system 130, one or more supply chain entities 140, and one or more computers 150 to network 160, any of zero packaging reverse logistics system 110, archiving system 120, planning and execution system 130, one or more supply chain entities 140, and one or more computers 150 may communicate directly with each other, according to particular needs.

In another embodiment, network 160 includes the Internet and any appropriate local area networks (LANs), metropolitan area networks (MANs), or wide area networks (WANs) coupling zero packaging reverse logistics system 110, archiving system 120, planning and execution system 130, one or more supply chain entities 140, and one or more computers 150. For example, data may be maintained locally to, or externally of, zero packaging reverse logistics system 110, archiving system 120, planning and execution system 130, one or more supply chain entities 140, and one or more computers 150 and made available to one or more associated users of zero packaging reverse logistics system 110, archiving system 120, planning and execution system 130, one or more supply chain entities 140, and one or more computers 150 using network 160 or in any other appropriate manner. For example, data may be maintained in a cloud database at one or more locations external to zero packaging reverse logistics system 110, archiving system 120, planning and execution system 130, one or more supply chain entities 140, and one or more computers 150 and made available to one or more associated users of zero packaging reverse logistics system 110, archiving system 120, planning and execution system 130, one or more supply chain entities 140, and one or more computers 150 using the cloud or in any other appropriate manner. Those skilled in the art will recognize that the complete structure and operation of network 160 and other components within supply chain network 100 are not depicted or described. Embodiments may be employed in conjunction with known communications networks and other components. Embodiments contemplate that at least part of network 160 may comprise a wireless personal area network (WPAN), such as, for example, Bluetooth or Zigbee.

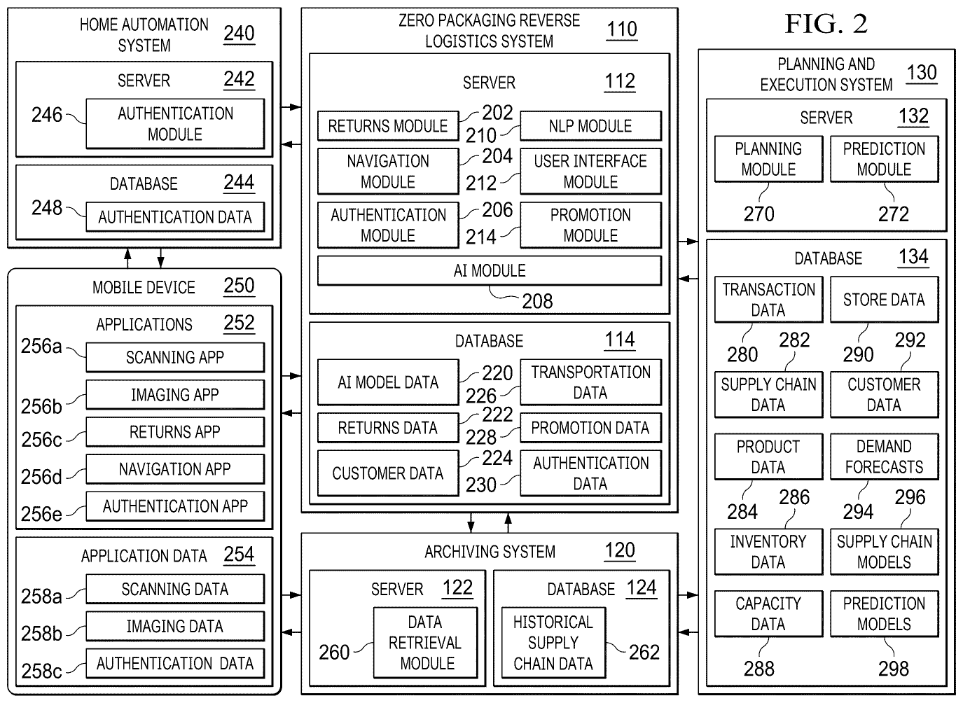

FIG. 2 illustrates zero packaging reverse logistics system 110, archiving system 120, and planning and execution system 130 of FIG. 1 in greater detail, as well as home automation system 240 and mobile device 250, in accordance with an embodiment. Zero packaging reverse logistics system 110 may comprise server 112 and database 114, as described above. Although zero packaging reverse logistics system 110 is illustrated as comprising a single server 112 and a single database 114, embodiments contemplate any suitable number of servers or databases internal to, or externally coupled with, zero packaging reverse logistics system 110.

Server 112 of zero packaging reverse logistics system 110 comprises returns module 202, navigation module 204, authentication module 206, artificial intelligence (AI) module 208, natural language processing (NLP) module 210, user interface module 212, and promotion module 214. Although server 112 is illustrated and described as comprising a single returns module 202, a single navigation module 204, a single authentication module 206, a single AI module 208, a single NLP module 210, a single user interface module 212, and a single promotion module 214, embodiments contemplate any suitable number or combination of these located at one or more locations local to, or remote from, zero packaging reverse logistics system 110, such as on multiple servers or one or more computers 150 at one or more locations in supply chain network 100.

In an embodiment, returns module 202 generates and/or provide any type of plan necessary for zero packaging reverse logistics. Returns module 202 may trigger based on a particular timing, such as, for example, a midnight trigger for next-day planning. In embodiments, returns module 202 generates a return collection plan, such as, for example, a pickup plan for products to be picked up by a collection resource at one or more customer locations, a receiving plan for one or more products that are shipped by one or more customers to a seller, distributor, and/or manufacturer location, and/or the like. Returns module 202 may further generate a return collection plan comprising one or more pick up addresses and one or more particular spaces and/or locations associated with the one or more pick up addresses where zero packaging product returns are to be picked up. For example, a return collection plan for a particular pickup may comprise a street address and a particular door for access to pick up a product return. The instructions for one or more return collection plans may also comprise one or more returns pickup vehicle identifiers, for example, to identify which of one or more returns pickup vehicles are assigned to pick up one or more product returns. In embodiments, returns module 202 may transmit the return collection plan to a mobile device of a collection resource, such as mobile device 250, to be presented and/or displayed to the collection resource. Embodiments further contemplate that for handling one or more product returns, returns module 202 may generate a loading plan for loading the one or more product returns in a returns pickup vehicle and present the loading plan to one or more loading resources, in which the loading resources may be the same or different resources as the collection resources. For example, the loading plan may specify grouping one or more product returns together for loading onto the same returns pickup vehicle. Returns module 202 may further detect the collecting of one or more product returns and validate the one more product returns, for example, by an inventory attribute such as a serial number.

According to embodiments, returns module 202 determines one or more product returns that do not require packaging based on one or more factors, such as, for example, based on a returns pickup vehicle configuration (e.g., whether the returns pickup vehicle has cushioned shelves, bins, and/or refrigeration), pickup related assets (e.g., AR glasses, waterproof containers, and/or bags), and/or a customer preference (e.g. agreement to return products without packaging and labelling). Returns module 202 may also generate an inbound staging plan for staging zero packaging product returns within a returns pickup vehicle and/or at a receiving location. By way of example only and not by way of limitation, the inbound staging plan may specify loading of a returns pickup vehicle to facilitate efficient utilization of vehicle capacity, such as by loading a first product return so as to not impede and/or otherwise hinder the loading of one or more other product returns. In embodiments, returns module 202 presents an inbound staging plan to one or more receiving resources, such as, for example, one or more retail store resources, warehouse resources, and/or return center resources, via mobile device 250 of the one or more receiving resources. The inbound staging plan may specify how return products are to be organized, such as, for example, by having the product returns oriented in a particular way to facilitate ease of scanning and/or identification of product returns. Embodiments contemplate that returns module 202 may generate and/or present one or more disposition steps and/or receiving locations for one or more product returns. By way of example only and not by way of limitation, returns module 202 may specify disposition steps such as sending a product return for a quality and/or functionality check, disposing of a product return, and/or returning the product return to a vendor or supplier. Continuing the example, returns module 202 may also specify particular locations, such as, for example, a particular area within a warehouse, where product returns may be staged and/or handled according to one or more returns processes, according to particular needs. Embodiments further contemplate that returns module 202 may detect any exception to notify any collection and/or receiving resource of the exception. Returns module 202 may further provide recommendations for additional packaging to use for particular products based on weather conditions, such as, for example, for a collection resource to place a product in a bag when making a product pickup during rainy weather and to return to the vehicle with the bag containing the product return.

In embodiments, returns module 202 considers one or more scenarios in generating a loading plan, such as, for example, taking into account that a returns pickup vehicle has no dedicated locations inside for storing one or more product returns or that a returns pickup vehicle has locations inside with capacity for holding more than one product return. The loading plan may also account for a sequence of pickups (e.g., loading one or more products picked up first so as to facilitate efficient further loading as the returns pickup vehicle makes further stops for additional pickups), and may identify locations on a returns pickup vehicle that may carry more than one product return (e.g., a bin as part of a rack for holding one or more product returns and/or an external rack for carrying one or more product returns). In another example, a return collection plan for a particular address may comprise making a product return pickup at a security office in a northwest corner of a first floor lobby of a high-rise apartment building. Embodiments further contemplate that returns module 202 may react to and adjust zero packaging reverse logistics plans based on unexpected contingencies and/or unexpected events during order fulfillment and/or returns fulfillment. By way of example only and not by way of limitation, when a pickup failure and/or denial of pickup occurs, returns module 202 may dynamically reassign the inventory identifier associated with the failed pickup to a new collection plan for pickup at a later time and/or date.

In an embodiment, navigation module 204 generates one or more routes for pickup of one or more product returns for zero packaging reverse logistics. To generate the one or more routes, navigation module 204 may provide a sequence of addresses with associated pickup locations and include time windows for each pickup. Embodiments contemplate that navigation module 204 may provide directions in any format, such as, for example, graphical, (e.g., a map with a highlighted route annotated with pickup locations), textual (e.g., an ordered list of pickup addresses with written instructions and/or directions pertaining to the route for the ordered list of pickup addresses), and/or verbal (e.g., aural and/or audio directions from an audio output device). The navigation directions may include both navigation for a returns pickup vehicle transporting one or more product returns and for a mobile device of a collection resource in collecting the product return at one or more pickup locations, such as mobile device 250. For example, navigation module 204 may generate the navigation directions for a particular device carried by a user, such as, for example, directions that account for local landmarks and/or street signs when a collection resource is wearing augmented reality (AR) glasses and using a bicycle as the mode of transportation vehicle (e.g., an instruction to turn left at the next convenience store). According to embodiments, navigation module 204 may generate the navigation directions in a format suitable for use by autonomous vehicles. By way of example only and not by way of limitation, when an autonomous drone is performing the zero packaging reverse logistics, the pickup address may comprise detailed global positioning system (GPS) coordinates corresponding to a backyard location inside a security fence. Embodiments further contemplate that navigation module 204 may provide real-time tracking of any returns pickup vehicle and/or collection resource. For example, when a collection resource is approaching an incorrect address and/or an incorrect door for access, navigation module 204 may provide an update and/or a notification to the collection resource of the navigational error.

In an embodiment, authentication module 206 generates temporal authentication credentials for a collection resource. As discussed in further detail below, the temporal authentication credentials may provide any kind of timed access to enable a collection resource to access a location to perform a pickup. According to embodiments, authentication module 206 may associate the temporal authentication credentials with a time limit during which access is granted and/or authorized. Authentication module 206 may generate and provide any type of code, token, and/or password necessary to provide access for a collection resource to perform a pickup. In embodiments, authentication module 206 communicates with home automation system 240 to generate the temporal authentication credentials. In such embodiments, authentication module 206 may provide home automation system 240 with the generated temporal authentication credentials. Authentication module 206 may further provide one or more temporal authentication credentials to mobile device 250 of a collection resource to enable the collection resource to access a pickup location via mobile device 250. According to embodiments, authentication module 206 may provide the temporal authentication credentials in electronic form (e.g., as an electronic token for providing access for pickup), as a printed and/or displayed code and/or password which may be entered for access by the collection resource for performing a pickup, in one or more biometric forms (e.g., using one or more fingerprints, iris scans, and/or facial recognition), or any other form, according to particular needs. In addition, or as an alternative, zero packaging reverse logistics system 110 or one or more other external systems may generate one or more one or more temporal authentication credentials when home automation system 240 authenticates zero packaging reverse logistics system 110 or the one or more other external systems, according to particular needs.

In an embodiment, AI module 208 may comprise one or more AI engines that provide one or more AI models, such as machine learning (ML) models, for use by zero packaging reverse logistics system 110. The one or more AI models may provide image recognition to verify the pickup, loading, and/or staging of one or more product returns, such as, for example, to verify that a picked up product is correct for a particular product return and/or to verify that a product return has been picked up at a correct location. For example, the one or more AI models may comprise one or more convolutional neural networks (CNNs) and/or one or more deep learning techniques to perform image recognition. According to embodiments, the one or more AI models also provide for recognition of one or more product returns for pickup. By way of example only and not by way of limitation, when a collection resource views a pickup location through AR glasses, AI module 208 may enable the collection resource to see a package that is highlighted for pickup at the pickup location.

In an embodiment, NLP module 210 implements natural language phrases related to information needs, customer input, verbal interaction with a customer, and the like. NLP module 210 may process customer input in specifying any data associated with a product return, such as, for example, a customer request date for pickup of a product return, a requested delivery service and/or any order modifications. According to embodiments, NLP module 210 further processes customer input in specifying any data in a customer profile (e.g., whether a customer agrees to zero packaging reverse logistics), customer inquiries (e.g., when a customer inquires as to a product return and/or pickup status for a requested product return), any collection resource inquiry (e.g., by a collection resource requesting a clarification of navigation instructions), or any other natural language communication relating to customers, product returns, and/or pickups.

In an embodiment, user interface module 212 generates and displays a user interface (UI), such as, for example, a graphical user interface (GUI), that displays zero packaging reverse logistics data or any other data of zero packaging reverse logistics system 110 in charts, graphs, histograms, or any other visual representations. According to embodiments, user interface module 212 displays a GUI comprising interactive graphical elements for configuring and managing any process associated with providing zero packaging reverse logistics and/or data of any kind stored in database 114 of zero packaging reverse logistics system 110. By way of example only and not by way of limitation, the GUI may present order data 222 and/or transportation data 226 associated with one or more products that are loaded in a returns pickup vehicle and/or staged in a receiving area after being unloaded from a returns pickup vehicle. User interface module 212 may further enable a customer to edit and/or view profile information associated with zero packaging reverse logistics. In embodiments, user interface module 212 may present a GUI that displays a promotion provided to a customer who has selected zero packaging reverse logistics. In addition, or as an alternative, user interface module 212 may generate non-visual interfaces, such as voice-based digital assistants, email messages, or other text-based messages, and present any zero packaging reverse logistics information to customers over such non-visual interfaces.

In an embodiment, promotion module 214 generates one or more promotions for a customer to incentivize and/or reward the customer for agreeing to zero packaging reverse logistics. For example, promotion module 214 may generate a promotion that includes a discount of a certain percentage or a certain amount for a future order when a customer agrees to zero packaging reverse logistics. According to embodiments, promotion module 214 personalizes the one or more promotions for particular customers. Promotion module 214 may further include a natural language message provided by NLP module 210 to present with the one or more promotions, such as, for example, to thank a customer for agreeing to zero packaging reverse logistics for one or more product returns, thank a customer for participating in an environmentally responsive program, and/or the like, to incentivize customers to agree to zero packaging reverse logistics based on sustainability, increasing customer loyalty, and improving company goodwill by communicating a commitment towards sustainable practices by offering zero packaging reverse logistics. In embodiments, promotion module 214 may be integrated with a customer loyalty program to, for example, offer loyalty program reward points or other loyalty program incentives.

Database 114 of zero packaging reverse logistics system 110 may comprise one or more databases or other data storage arrangements at one or more locations local to, or remote from, server 112. Database 114 of zero packaging reverse logistics system 110 comprises, for example, AI model data 220, returns data 222, customer data 224, transportation data 226, promotion data 228, and authentication data 230. Although database 114 of zero packaging reverse logistics system 110 is illustrated and described as comprising AI model data 220, order data 222, customer data 224, transportation data 226, promotion data 228, and authentication data 230, embodiments contemplate any suitable number or combination of data located at one or more locations local to, or remote from, zero packaging reverse logistics system 110, according to particular needs.

In an embodiment, AI model data 220 comprises data describing or characterizing one or more models that provide image recognition of one or more products and/or product packaging of one or more products, such as parameters characterizing the one or more models. AI model data 220 may comprise models capable of distinguishing and/or recognizing different products and/or product packaging which are arrayed and/or stacked, such as, for example, one or more AI models able to recognize and/or distinguish between different positions of a product placed at a pickup location, so as to provide an indication and/or highlight to a collection resource to remove a product at a pickup location as a product return. The AI models may further provide recognition of one or more products which are grouped and/or staged after unloading from a returns pickup vehicle, such as, for example, by providing image recognition of products in a group and/or stacked on a pallet which have been unloaded and organized for zero packaging reverse logistics processing. By way of example only and not by way of limitation, when a customer requests a return pickup of a particular smartphone model, image recognition using an AI model of AI model data 220 may ensure that the particular model was picked up for a return and not a similar looking smartphone model. Embodiments further contemplate zero packaging reverse logistics system 110 updating AI model data 220 over time to improve the ability of the one or more AI models to learn and/or perform image recognition.

In an embodiment, returns data 222 comprises any data describing orders of customers and/or product returns associated with orders of customers. For example, returns data 222 may describe attributes of a product return such as product description, SKU, quantity, scheduled pickup date and/or time, and the like. According to embodiments, returns data 222 also comprises any data describing and/or providing a physical description and/or image recognition of one or more particular products in a product return. By way of example only and not by way of limitation, when two different smartphone models are packaged in similar packaging, returns data 222 provides distinguishing information between the two different packages to enable a resource to pick up the correct smartphone for return. In embodiments, returns data 222 further comprises data describing supply chain attributes of a product return. For example, returns data 222 may describe one or more manufacturing sites and/or suppliers that manufacture and/or provide reverse logistics processing for all or part of an order, one or more warehouses and/or distribution centers that are associated with a product return, describe whether a customer has subscribed and/or agreed to zero packaging reverse logistics for a particular product return, and/or specific customer instructions and/or directions for a product return (e.g., where and how a product return is to be picked up, such as “on the back porch” or “by the front door”). Embodiments contemplate that returns data 222 may further comprise data used by an order management system, warehouse management system, transportation management system, and/or warehouse management system to process and/or handle a product return, as well as any warranty data indicating product return rates for defective products.

In an embodiment, customer data 224 comprises data of shoppers, customers, consumers, or other purchasers of goods or services within supply chain network 100, including individuals, businesses, or other entities. For example, customer data 224 may include customer purchase history and/or product return data, customer visit pattern data, customer location data, and known customer requirements data. According to embodiments, returns module 202 may derive customer requirements by analyzing customer data 224 such as customer calendar data, social media data associated with customers, customer service interactions taking place after order placement, IoT data collected from IoT devices associated with customers, and customer profiles and preferences. Customer data 224 may include demographic data such as, for example, addresses, locations, occupations, or any other demographic data, as well as data regarding a customer subscription for zero packaging reverse logistics for particular product returns or all product returns. User interface module 212 may provide a UI that enables a customer to update preferences in a customer profile regarding whether to have zero packaging reverse logistics for any product return pickups and/or for certain types of product return pickups.

In embodiments, customer data 224 further comprises instructions pertaining to any contingency. For example, customer data 224 may include instructions for what to do when a customer is not at home when an attempted pickup is made, such as picking up the product without packaging at a particular location at the pickup address (e.g., on a front porch), making another attempt at pickup at a later date and/or time, and/or the like. Such instructions may comprise directions specific to customers and/or pickup locations, such as, for example, specifying that an expensive product is to be placed in a bag and/or container for pickup by a collection resource that hides the identify of the expensive product or with a security team of a gated community or apartment for pickup by the collection resource when a customer is returning an expensive product. Customer data 224 may also comprise a particular communication channel of how the customer is to be notified of product return status, such as, for example, by email, text message, and the like. Embodiments further contemplate that customer data 224 may be updated to change customer preferences for a particular product return. By way of example only and not by limitation, a customer may wish to update their profile to not have zero packaging reverse logistics applied to a particular order, while opting in for zero packaging reverse logistics on other orders. In embodiments, customer data 224 further includes customer interactions with customer service channels or self-service channels, such as call center interactions, website or app interactions, social media interactions, in-person interactions, email interactions, or any other interactions with customer service associated with supply chain network 100, as well as various data related to all customers or groups of customers of supply chain network 100, such as customer clusters or segments that include a particular customer or any other grouping of customers based on similarity, customer profiles, customer preferences, and/or the like. NLP module 210 may analyze any natural language customer data 224, such as, for example, a message or interaction data of customers, using NLP techniques or models, such as support vector machines (SVMs), term frequency (TF) models, term frequency inverse document frequency (TF-IDF) models, bag-of-words models, logistic regression models, Naïve Bayes models, decision trees, hidden Markov models, convolutional neural networks, recurrent neural networks, auto-encoder models, and/or NLP transformers, although other NLP techniques may be used according to particular needs.

In an embodiment, transportation data 226 comprises data characterizing one or more vehicles and data characterizing one or more routes used for product return pickup. For example, transportation data 226 may comprise a weight, space, and/or volume capacity associated with one or more returns pickup vehicles capable of providing zero packaging reverse logistics. In another example, transportation data 226 may comprise a returns pickup vehicle scheduled to travel a particular vehicular route that includes traversing a particular road or highway. In embodiments, transportation data 226 describes one or more types of capacities and/or capabilities associated with zero packaging reverse logistics. For example, transportation data 226 may describe a capability of a returns pickup vehicle to transport one or more fragile items using padded bins and/or containers installed in a returns pickup vehicle. Transportation data 226 may further include storage configuration information of a returns pickup vehicle, such as total number of bins, bins with padding support, refrigeration capacity, and sizes of the bins. Embodiments contemplate transportation data 226 further comprising one or more particular types of returns pickup vehicles to utilize for delivery (e.g., bicycle, car, truck, rail, air, marine, drone, robot, etc.), a combination of modes of transportation for returns pickup, a type of route schedule or route list (e.g., a number of returns pickup locations according to an order or according to a time schedule, wherein the time schedule may be according to fixed times or windows of time), a type of vehicular power (e.g., fossil fuels such as gasoline, diesel, or compressed natural or liquified natural gas, electrical, battery-operated, hybrid sources of vehicular fuels, and/or human power), and/or actual or estimated cost data associated with one or more returns pickup vehicles and/or one or more routes used for delivery of one or more orders.

In an embodiment, promotion data 228 comprises any data characterizing and/or describing promotions generated for a customer to incentivize and/or reward customer selection of zero packaging reverse logistics. For example, promotion data 228 may include a discount amount or percentage of a promotion. Promotion data 228 may also contain message data associated with one or more promotions communicating a commitment of a company or enterprise to sustainability and/or environmental responsibility. According to embodiments, promotion module 214 generates the one or more promotions in a personalized manner and may include discounts and/or other incentives specific to individual customers, as disclosed above.

In an embodiment, authentication data 230 comprises any data describing and/or characterizing temporal authentication credentials. A temporal authentication credential may comprise any kind of electronic, physical, and/or biometric credential capable of granting access to a pickup location, such as, for example, a key code for a door, a credential on a wireless key card to unlock a door, or a security token transmitted via an interface (e.g., via USB, near-field communication, radio-frequency identification (RFID), Bluetooth, etc.). In embodiments, authentication data 230 includes one or more temporal aspects and/or attributes of an authentication credential, such as a time duration or period during which an authentication credential is viable. A temporal attribute of an authentication credential may comprise a fixed duration of time, such as, for example, from 1:00-3:00 PM on a Monday, or a time duration which elapses upon granting of access, such as, for example, a five-minute duration that begins after a collection resource is granted access. By way of example only and not by way of limitation, an authentication credential may have an access time of two minutes upon a collection resource arriving at a pickup location to enable time for the collection resource to make a pickup. According to embodiments, a biometric credential may include any kind of biometric identifier, such as fingerprint scan and/or iris scan data, facial recognition data, gait analysis data, or any other type of biometric data that provides identification of a collection resource.

Home automation system 240 comprises server 242 and database 244. Although home automation system 240 is illustrated as comprising a single server and a single database, embodiments contemplate any suitable number of servers or databases internal to, or externally coupled with, home automation system 240. As disclosed above, one or more customers of one or more supply chain entities 140 may comprise a home automation system, such as home automation system 240, which may provide a delivery resource access to a delivery location. In addition, or as an alternative, home automation system 240 may be an automation system of a customer premise, such as, for example, a warehouse and a store in case of a business customer, where products are returned by the customer. According to embodiments, home automation system 240 may be integrated with zero packaging reverse logistics system 110.

Server 242 of home automation system 240 comprises authentication module 246. Although server 242 is illustrated and described as comprising a single authentication module 246, embodiments contemplate any suitable number or combination of authentication modules located at one or more locations local to, or remote from, home automation system 240, such as on multiple servers or one or more computers 150 at one or more locations in supply chain network 100.

In an embodiment, authentication module 246 of home automation system 240 receives temporal authentication credentials from zero packaging reverse logistics system 110 and/or mobile device 250 to enable a collection resource to access a pickup location for a zero packaging product return. As discussed in greater detail above, the temporal authentication credentials may comprise any type of code, token, and/or password to provide access to a delivery location, such as an electronic token, a code or password, biometric data, and/or the like. According to embodiments, authentication module 246 may also communicate with mobile device 250 of a collection resource to receive and/or transmit temporal authentication credentials. In addition, authentication module 246 may enable monitoring using a smart home infrastructure. As described in further detail below, authentication module 246 may utilize a security or surveillance infrastructure of a pickup location according to the temporal authentication credentials. For example, when temporal authentication credentials provide for a collection resource to access the pickup area for five minutes, authentication module 246 may enable a security camera to record the pickup area for the duration of the five minutes that the collection resource has access to the pickup area. In embodiments, the monitoring may comprise image recognition to detect and/or determine whether and/or when a collection resource enters a pickup location, as described in greater detail above. Authentication module 246 may further disable monitoring of the collection resource and/or pickup location according to the temporal authentication credentials and/or upon the collection resource exiting the pickup area. Authentication module 246 may further notify the customer when the collection resource exceeds the temporal factor in the pickup area according to the monitoring.

Database 244 of home automation system 240 may comprise one or more databases or other data storage arrangements at one or more locations local to, or remote from, server 242. Database 244 of home automation system 240 comprises, for example, authentication data 248. Although database 244 of home automation system 240 is illustrated and described as comprising automation data 248, embodiments contemplate any suitable number or combination of data located at one or more locations local to, or remote from, home automation system 240, according to particular needs.

Authentication data 248 of home automation system 240 comprises temporal authentication credentials received from zero packaging reverse logistics system 110 and/or mobile device 250 to enable a collection resource to access a pickup location for a zero packaging product return. As disclosed above, authentication data 248 may comprise a temporal attribute such as a fixed duration of time or a time duration which elapses upon granting of access that begins after a collection resource is granted access. In embodiments, authentication data 248 further comprises monitoring data, such as video feeds, video recordings, motion sensor data, and the like.

As illustrated in FIG. 2, mobile device 250 comprises applications 252 and application data 254. As disclosed above, one or more computers 150 of supply chain network 100 may comprise one or more mobile devices, such as mobile device 250. Applications 252 of mobile device 250 comprise scanning app 256a, imaging app 256b, returns app 256c, navigation app 256d, and authentication app 256e. Although applications 252 are illustrated and described as comprising a single scanning app 256a, a single imaging app 256b, a single returns app 256c, a single navigation app 256d, and a single authentication app 256e, embodiments contemplate any suitable number or combination of these located at one or more locations local to, or remote from, mobile device 250, such as on multiple servers or one or more computers 150 at one or more locations in supply chain network 100. In embodiments, mobile device 250 may comprise any portable computing device, such as a smartphone or tablet. Embodiments contemplate that mobile device 250 may comprise any kind of mobile, wearable computing device, such as an AR device (e.g., AR glasses). Embodiments further contemplate that mobile device 250 may comprise any kind of brain-computer interface (BCI). According to embodiments, mobile device 250 may be wholly or partially integrated with a returns pickup vehicle, such as, for example, with one or more navigational systems of the returns pickup vehicle. Mobile device 250 may further comprise one or more combinations of devices, such as, for example, a vehicle navigational system displaying navigational directions and/or instructions for pickup and a mobile phone displaying an access code for a keypad on a door. The combination of devices may comprise instructions shared between mobile devices of multiple collection resources, such as, for example, by displaying driving directions on mobile device 250 of a driver of a returns pickup vehicle and collection instructions being displayed on mobile device 250 of another collection resource that performs the pickup. In addition, or as an alternative, mobile device 250 may comprise electronic and printed and/or written instructions. For example, navigational directions and/or pickup instructions may comprise a printed map with navigational directions and mobile device 250 with instructions for where to pick up a product for a product return. Embodiments contemplate that mobile device 250 may notify a resource of any exception identified during operation of an application through any means of notification, such as, for example, by a message, an indicator, a sound, a vibration, and/or a tone. By way of example only and not by way of limitation, mobile device 250 may provide a notification of an exception that a collection resource has picked up an incorrect package from a pickup location by beeping and/or vibrating.

In an embodiment, scanning app 256a provides any kind of scanning of one or more products. For example, scanning app 256a may provide scanning of optical barcodes, quick response (QR) codes, RFID chips, and the like. Scanning app 256a may also provide confirmation that a particular product being picked up is correct for a product return, inventory information and/or other information upon scanning of a product and/or product packaging, and/or an ordered list of one or more products to pick up as one or more product returns while indicating the one or more products as picked up when a collection resource picks up and/or loads the one or more products on a returns pickup vehicle. Embodiments further contemplate that scanning app 256a may generate one or more exceptions as a result of scanning, such as, for example, when a product that has been picked up has been incorrectly placed in one bin when collection and/or loading instructions specify another bin.

In an embodiment, imaging app 256b provides image recognition of one or more scanned products and/or product packaging, for example, to verify that a particular product and/or packaged product is correct for a product return. Imaging app 256b may utilize one or more AI image-recognition models or techniques, such as a CNN, to recognize and/or verify one or more products are correct for a product return. According to embodiments, imaging app 256b may recognize one or more products based, at least in part, on one or more catalog images provided by one or more supply chain entities 140. Imaging app 256b may provide confirmation that one or more products are correctly staged and/or organized after unloading from a returns pickup vehicle upon receiving an image of a product staging or unloading area, one or more images verifying and/or documenting that one or more products have been picked up, and/or recognition of one or more products that are contained in a pickup receptacle located at a pickup location to highlight which product to extract and/or withdraw for pickup. Imaging app 256b may further match an image of a picked up product with an image of the product at a pickup location to determine whether the product is correct for a product return. Embodiments contemplate that imaging app 256b may provide recognition of non-packaged products, such as any loose parts or items (e.g., stainless steel screws), to ensure that the correct product is picked up for a product return. By way of example only and not by way of limitation, imaging app 256b may distinguish between different colors and/or styles of clothing to ensure that the correct clothing item is picked up for a product return. Embodiments further contemplate that imaging app 256b may provide recognition and/or quantification of any product characteristic and/or attribute, such as, for example, to infer an amount of wear and/or disposition of a clothing item for a product return, and may determine other visual product characteristics and/or attributes, such as determining the length and/or other physical dimension of a product (e.g., a fastener length and/or diameter).

In an embodiment, returns app 256c provides instructions to pick up and/or stage one or more products for a product return. For example, returns app 256c may provide a list of one or more products to pick up and how to group and/or stack the one or more products after unloading from a returns pickup vehicle. Returns app 256c may consider a sequence to pick up products so as to enable efficient loading of one or more product returns on a returns pickup vehicle, such as, for example, by specifying how to load the initial product returns to improve a loading efficiency and/or ease of loading of later product returns. According to embodiments, returns app 256c provides instructions of how to load one or more product returns on a returns pickup vehicle (e.g., by specifying the use of padded bins to carry one or more fragile products and/or specifying that longer items are to be placed onto external racks on the returns pickup vehicle), specifies one or more types of temporary packaging to use to protect one or more product returns during a product return (e.g., by specifying a water-proof cover to protect a product from inclement weather or by specifying a packaging that hides and/or obscures a product identity when the product is valuable, such as a smartphone or a jewelry item, to prevent and/or discourage theft), and/or specifies how to utilize one or more types of temporary packaging (e.g., specifying to pick up and carry a product return in a waterproof bag to the returns pickup vehicle or specifying to cover the product with temporary packaging when a valuable product is to be left outside at a residence during inclement weather).

In an embodiment, navigation app 256d provides one or more directions for navigation of a returns pickup vehicle to make one or more product return pickups. For example, navigation app 256d may provide one or more directions comprising a series of routes and/or stops required to perform one or more product return pickups. In embodiments, navigation app 256d provides the one or more directions in various forms and/or formats, such as, for example, by communicating the directions to a navigation system of a returns pickup vehicle that a collection resource uses to perform one or more product return pickups, by displaying a digital map with highlighted waypoints, by displaying a list of textual instructions, displaying a combination of graphical and textual instructions, and/or the like. Embodiments further contemplate that navigation app 256d may provide directions necessary and/or appropriate for a particular type of returns pickup vehicle. By way of example only and not by way of limitation, navigation app 256d may provide GPS coordinates, along with other directions such as information regarding controlled airspace, aerial approaches for airports, and/or other aerial navigation hazards to avoid (e.g., power lines, water towers, etc.) to a drone for the drone to complete one or more product return pickups. Navigation app 256d may also provide directions that consider one or more current, forecasted, and/or predicted conditions, such as, for example, traffic conditions, weather conditions, road closures, road construction, and the like.

In an embodiment, authentication app 256e provides any kind of temporal authentication credential necessary for a collection resource to gain access to pick up one or more products. As described in greater detail above, authentication app 256e may receive one or more temporal authentications from zero packaging reverse logistics system 110 and/or home automation system 240. Authentication app 256e may communicate and/or transmit one or more temporal authentication credentials to home automation system 240 and/or one or more other external systems or display one or more temporal authentication credentials (e.g., to enter a door keycode for entry) for a collection resource to utilize to gain access to perform a pickup. In embodiments, authentication app 256e tracks and/or displays a status of one or more temporal attributes associated with an authentication credential, such as, for example, an amount of time remaining before an authentication credential expires.

Embodiments further contemplate that the apps and/or functions of mobile device 250 may be integrated into one or more workflows and/or processes to provide robust, fault tolerant, and/or efficient zero packaging reverse logistics. In embodiments, a trigger and/or event detected by one or more apps may cause one or more other apps to perform one or more functions, according to particular needs. By way of example only and not by way of limitation, navigation app 256d detecting a returns pickup vehicle approaching and/or stopped at a particular address may cause imaging app 256b to display one or more pictures of one or more products to be picked up at that particular address to assist a collection resource in correctly identifying the one or more products to pick up. Continuing this example, when navigation app 256d of mobile device 250 further detects a collection resource approaching a secure door, navigation app 256d may cause authentication app 256e to access authentication data 230 of zero packaging reverse logistics system 110 and/or authentication data 248 of home automation system 240 and display and/or transmit an access code to enable the secure door to be opened, and may access a messaging function of mobile device 250 to text a notification to a customer that their product return is in progress. Further in this example, when the collection resource uses scanning app 256a and/or imaging app 256b to scan and/or image the one or more products at the correct pickup location as confirmed by navigation app 256d, scanning app 256a may cause a notification and/or one or more product return images to be transmitted to the customer to confirm correct pickup of the one or more products at the pickup location. Embodiments contemplate any permutation, combination, order, and/or repetition of one or more apps and/or one or more functions of mobile device 250, according to particular needs.

Application data 254 of mobile device 250 may comprise one or more databases or other data storage arrangements at one or more locations local to, or remote from, applications 252. Application data 254 comprises, for example, scanning data 258a, imaging data 258b, and authentication data 258c. Although application data 254 is illustrated and described as comprising scanning data 258a, imaging data 258b, and authentication data 258c, embodiments contemplate any suitable number or combination of data located at one or more locations local to, or remote from, mobile device 250, according to particular needs.

In an embodiment, scanning data 258a comprises any data produced and/or utilized by scanning app 256a. For example, scanning data 258a may comprise data describing and/or characterizing one or more barcodes, one or more QR codes, one or more RFID tags, and/or the like. According to embodiments, scanning data 258a includes any data describing and/or characterizing a scanned product, such as, for example, a manufacturer, a model number, a serial number, a device ID (e.g., international mobile equipment identity (IMEI), mobile equipment identifier (MEID), electronic serial number (ESN), etc.), and the like. Scanning data 258a may further comprise any data that verifies and/or confirms that one or more picked up, loaded, and/or staged products are correct for a particular product return. In embodiments, one or more applications 252 of mobile device 250 may utilize scanning data 258a to update a product return status at any time during a reverse logistics process, such as, for example, upon picking up, loading, and/or staging one or more product returns. In embodiments, mobile device 250 may transmit scanning data 258a to any other system of supply chain network 100, such as, for example, zero packaging reverse logistics system 110, archiving system 120, and/or home automation system 240, according to particular needs. By way of example only and not by way of limitation, mobile device 250 may transmit scanning data 258a to a system tracking a product return status to provide one or more indications of a status of a product return, such as a confirmation of a pickup or a location along a route.

In an embodiment, imaging data 258b comprises any data characterizing and/or describing images of one or more product returns in a supply chain reverse logistics process. For example, imaging data 258b may comprise one or more catalog and/or stock images of a product and/or packaging of a product. In embodiments, imaging data 258b also comprises one or more images providing instructions for how and/or which one or more product returns are to be picked up, loaded, and/or staged, as well as one or more images documenting how and/or which one or more product returns were picked up, loaded, and/or staged, for example, to document proper handling and processing of one or more product returns. In other examples, imaging data 258b may provide one or more images for a collection resource to use to verify that a correct product is being picked up for a product return (e.g., by displaying a correct image of the product), one or more comparison images to aid a collection and/or receiving resource (e.g., to distinguish a correct product for a product return versus similar looking but incorrect products for the product return), and/or one or more products for a product return associated with other data (e.g., an image of a smartphone with an inventory identifier such as a SKU or model number).

In an embodiment, authentication data 258c comprises any data characterizing and/or describing one or more temporal authentication credentials. For example, authentication data 258c may comprise any kind of code, token, and/or password necessary to provide access for a collection resource to perform a pickup. In embodiments, authentication data 258c may be retrieved and/or used by authentication app 256e to obtain access to a secure pickup area for performing a pickup of one or more product returns. Authentication data 258c may be stored in an encrypted and/or unencrypted manner, according to particular needs.

As discussed above, archiving system 120 comprises server 122 and database 124. Although archiving system 120 is illustrated as comprising a single server 122 and a single database 124, embodiments contemplate any suitable number of servers or databases internal to, or externally coupled with, archiving system 120.

Server 122 of archiving system 120 comprises data retrieval module 260. Although server 122 is illustrated and described as comprising a single data retrieval module 260, embodiments contemplate any suitable number or combination of data retrieval modules located at one or more locations local to, or remote from, archiving system 120, such as on multiple servers or one or more computers 150 at one or more locations in supply chain network 100.

In one embodiment, data retrieval module 260 of archiving system 120 receives historical supply chain data 262 from planning and execution system 130 and one or more supply chain entities 140 and stores received historical supply chain data 262 in archiving system 120 database 124. According to one embodiment, data retrieval module 260 may prepare historical supply chain data 262 for use as training data by checking historical supply chain data 262 for errors and transforming historical supply chain data 262 to normalize, aggregate, and/or rescale historical supply chain data 262 to enable direct comparison of data received from planning and execution system 130, one or more supply chain entities 140, and/or one or more other locations local to, or remote from, archiving system 120. According to embodiments, data retrieval module 260 may receive data from one or more sources external to supply chain network 100, such as, for example, weather data, special events data, social media data, calendar data, and the like, and store the received data as historical supply chain data 262.

Database 124 of archiving system 120 may comprise one or more databases or other data storage arrangements at one or more locations local to, or remote from, server 122. Database 124 of archiving system 120 comprises, for example, historical supply chain data 262. Although database 124 of archiving system 120 is illustrated and described as comprising historical supply chain data 262, embodiments contemplate any suitable number or combination of data located at one or more locations local to, or remote from, archiving system 120, according to particular needs.

Historical supply chain data 262 comprises historical data received from zero packaging reverse logistics system 110, planning and execution system 130, one or more supply chain entities 140, and/or one or more computers 150. Historical supply chain data 262 may comprise, for example, weather data, special events data, social media data, calendar data, and the like. Historical supply chain data 262 may further comprise, for example, historic order data, shipment data, and product returns data. In an embodiment, historical supply chain data 262 may comprise, for example, historic sales patterns, prices, promotions, weather conditions, and other factors influencing future demand of the number of one or more items sold and/or returned in one or more stores over a time period, such as, for example, one or more days, weeks, months, or years, including, for example, a day of the week, a day of the month, a day of the year, a week of the month, a week of the year, a month of the year, special events, paydays, and the like.

As discussed above, planning and execution system 130 comprises server 132 and database 134. Although planning and execution system 130 is illustrated as comprising a single server 132 and a single database 134, embodiments contemplate any suitable number of servers or databases internal to, or externally coupled with, planning and execution system 130.

In embodiments, server 132 of planning and execution system 130 comprises planning module 270 and prediction module 272. Although server 132 is illustrated and described as comprising a single planning module 270 and a single prediction module 272, embodiments contemplate any suitable number or combination of planning modules and prediction modules located at one or more locations local to, or remote from, planning and execution system 130, such as on multiple servers or one or more computers 150 at one or more locations in supply chain network 100.

Planning module 270 of planning and execution system 130 works in connection with prediction module 272 to generate a plan based on one or more predicted retail volumes, product return volumes, classifications, or other predictions. By way of example and not of limitation, planning module 270 may comprise a demand planner that generates a demand forecast for one or more supply chain entities 140. Planning module 270 may generate the demand forecast, at least in part, from predictions and calculated factor values for one or more causal factors received from prediction module 272. By way of a further example, planning module 270 may comprise an assortment planner and/or a segmentation planner that generates product assortments that match causal effects calculated for one or more customers or products by prediction module 272, which may provide for increased customer satisfaction and sales, as well as reduce costs for shipping and stocking products at stores where they are unlikely to sell. Embodiments contemplate that planning module 270 may comprise a promising server that may provide available-to-promise (ATP) and/or other information for promising one or more orders.

Prediction module 272 of planning and execution system 130 applies samples of transaction data 280, supply chain data 282, product data 284, inventory data 286, capacity data 288, store data 290, customer data 292, demand forecasts 294, and other data to prediction models 298 to generate predictions and calculated factor values for one or more causal factors. Prediction module 272 of planning and execution system 130 may predict a volume Y (target) from a set of causal factors X along with causal factors strengths that describe the strength of each causal factor variable contributing to the predicted volume, which may be a demand volume or a product returns volume, according to particular needs. According to some embodiments, prediction module 272 generates predictions at daily intervals. However, embodiments contemplate longer and shorter prediction phases that may be performed, for example, weekly, twice a week, twice a day, hourly, or the like.

Database 134 of planning and execution system 130 may comprise one or more databases or other data storage arrangements at one or more locations local to, or remote from, server 132. Database 134 of planning and execution system 130 comprises, for example, transaction data 280, supply chain data 282, product data 284, inventory data 286, capacity data 288, store data 290, customer data 292, demand forecasts 294, supply chain models 296, and prediction models 298. Although database 134 of planning and execution system 130 is illustrated and described as comprising transaction data 280, supply chain data 282, product data 284, inventory data 286, capacity data 288, store data 290, customer data 292, demand forecasts 294, supply chain models 296, and prediction models 298, embodiments contemplate any suitable number or combination of data located at one or more locations local to, or remote from, planning and execution system 130, according to particular needs.

Transaction data 280 of planning and execution system 130 may comprise recorded sales transactions, product returns transactions, and related data, including, for example, a transaction identification, time and date stamp, channel identification (such as stores or online touchpoints), product identification, actual cost, selling price, sales volume, product returns volume, customer identification, promotions, and/or the like. In addition, transaction data 280 is represented by any suitable combination of values and dimensions, aggregated or disaggregated, such as, for example, sales per week, sales per week per location, sales per day, sales per day per season, or the like.

Supply chain data 282 may comprise any data of one or more supply chain entities 140 including, for example, item data, identifiers, metadata (comprising dimensions, hierarchies, levels, members, attributes, cluster information, and member attribute values), fact data (comprising measure values for combinations of members), business constraints, goals, and objectives of one or more supply chain entities 140.

Product data 284 of database 134 may comprise products identified by, for example, a product identifier (such as a SKU, Universal Product Code (UPC), or the like) and one or more attributes and attribute types associated with the product ID. Product data 284 may comprise data about one or more products organized and sortable by, for example, product attributes, attribute values, product identification, product components, sales volume, demand forecast, quantity of returns, or any stored category or dimension. Attributes of one or more products may be, for example, any categorical characteristic, structural characteristic, or quality of a product, and an attribute value may be a specific value or identity for the one or more products according to the categorical characteristic or quality, including, for example, physical parameters (such as, for example, size, weight, dimensions, color, and the like). Product data 284 may further comprise one or more images of a product, such as, for example, one or more catalog images of a product.

Inventory data 286 of database 134 may comprise any data relating to current or projected inventory quantities or states, order rules, or the like. For example, inventory data 286 may comprise the current level of inventory for each item at one or more stocking points across supply chain network 100. In addition, inventory data 286 may comprise order rules that describe one or more rules or limits on setting an inventory policy, including, but not limited to, a minimum order volume, a maximum order volume, a discount, and a step-size order volume, and batch quantity rules. According to some embodiments, planning and execution system 130 accesses and stores inventory data 286 in database 134, which may be used by planning and execution system 130 to place orders, set inventory levels at one or more stocking points, initiate manufacturing of one or more components, or the like.

In embodiments, inventory data 286 may also comprise one or more inventory policies. The inventory policies may comprise any suitable inventory policy describing the reorder point and target quantity, or other inventory policy parameters that set rules for planning and execution system 130 to manage and reorder inventory. The inventory policies may be based on target service level, demand, cost, fill rate, or the like. According to embodiments, the inventory policies comprise target service levels that ensure that a service level of one or more supply chain entities 140 is met with a set probability. For example, one or more supply chain entities 140 may set a service level at 95%, meaning one or more supply chain entities 140 sets the desired inventory stock level at a level that meets demand 95% of the time. Although a particular service level target and percentage is described, embodiments contemplate any service target or level, such as, for example, a service level of approximately 99% through 90%, a 75% service level, or any suitable service level, according to particular needs. Other types of service levels associated with inventory quantity or order quantity may comprise, but are not limited to, a maximum expected backlog and a fulfillment level. Once the service level is set, planning and execution system 130 may determine a replenishment order according to one or more replenishment rules, which, among other things, indicates to one or more supply chain entities 140 to determine or receive inventory to replace the depleted inventory. By way of example only and not by way of limitation, an inventory policy for non-perishable goods with linear holding and shorting costs comprises a min./max. (s,S) inventory policy. Other inventory policies may be used for perishable goods, such as fruit, vegetables, dairy, and fresh meat, as well as electronics, fashion, and similar items for which demand drops significantly after a next generation of electronic devices or a new season of fashion is released.

Capacity data 288 of database 134 may comprise any data relating to current or projected resource capacity values or states, order rules, or the like. For example, capacity data 288 may comprise the current level of capacity for each task at one or more locations across supply chain network 100. In addition, capacity data 288 may comprise order rules that describe one or more rules or limits on setting a capacity policy, including, but not limited to, a minimum order capacity, a maximum order capacity, a discount, a step-size order capacity, and batch quantity rules. According to some embodiments, planning and execution system 130 accesses and stores capacity data 288 in database 134, which may be used by planning and execution system 130 to place orders, set capacity levels at one or more locations in supply chain network 100, initiate manufacturing of one or more components, or the like.

In embodiments, capacity data 288 may include one or more capacity policies. The capacity policies may comprise any suitable capacity policy describing the reorder point and target quantity, or other capacity policy parameters that set rules for planning and execution system 130 to manage capacity. The capacity policies may be based on target service level, demand, cost, or the like. According to embodiments, the capacity policies comprise target service levels that ensure that a service level of one or more supply chain entities 140 is met with a set probability. For example, one or more supply chain entities 140 may set a service level at 95%, meaning one or more supply chain entities 140 sets the desired capacity level at a level that meets demand 95% of the time.

Store data 290 may comprise data describing the stores of one or more retailers and related store information. Store data 290 may comprise, for example, a store ID, store description, store location details, store location climate, store type, store opening date, lifestyle, store area (expressed in, for example, square feet, square meters, or other suitable measurement), latitude, longitude, and other similar data.

Customer data 292 of planning and execution system 130 may comprise customer identity information, including, for example, customer relationship management data, loyalty programs, and mappings between product purchases and one or more customers so that a customer associated with a transaction may be identified. Customer data 292 may further comprise data relating customer purchases to one or more products, geographical regions, store locations, or other types of dimensions. In an embodiment, customer data 292 may also comprise customer profile information, including demographic information and preferences, as well as product browsing data, customer service interaction data, and UI analytics data of customers.

Demand forecasts 294 of database 134 may indicate expected future demand based on, for example, any data relating to past sales, past demand, purchase data, product returns, promotions, events, or the like of one or more supply chain entities 140. Demand forecasts 294 may cover a time interval such as, for example, by the minute, by the hour, daily, weekly, monthly, quarterly, yearly, or any other suitable time interval, including substantially in real time. In some embodiments, demand may be modeled as a negative binomial or Poisson-Gamma distribution. According to other embodiments, the model also takes into account shelf-life of perishable goods (which may range from days (e.g., fresh fish or meat) to weeks (e.g., butter) or even months, before any unsold items have to be written off as waste) as well as influences from promotions, price changes, rebates, coupons, and even cannibalization effects within an assortment range. In addition, customer behavior is not uniform but varies throughout the week and is influenced by seasonal effects and the local weather, as well as many other contributing factors. Accordingly, even when demand generally follows a Poisson-Gamma model, the exact values of the parameters of the model may be specific to a single product to be sold on a specific day in a specific location or sales channel and may depend on a wide range of frequently changing influencing causal factors. By way of example only and not by way of limitation, an exemplary supermarket may stock twenty thousand items at one thousand locations. When each location of this exemplary supermarket is open every day of the year, planning and execution system 130 needs to calculate approximately 2×10\hat{ }10 demand forecasts 294 each day to derive the optimal order volume for the next delivery cycle (e.g., three days).

Supply chain models 296 of database 134 comprise characteristics of a supply chain setup to deliver the customer expectations of a particular customer business model. These characteristics may comprise differentiating factors, such as, for example, MTO (Make-to-Order), ETO (Engineer-to-Order), or MTS (Make-to-Stock). However, supply chain models 296 may also comprise characteristics that specify the supply chain structure in even more detail, including, for example, specifying the type of collaboration with the customer (e.g., Vendor-Managed Inventory (VMI)), from where products may be sourced, and how products may be allocated, shipped, or paid for by particular customers. Each of these characteristics may lead to a different supply chain model. Prediction models 298 comprise one or more of the trained models used by planning and execution system 130 for predicting, among other variables, pricing, targeting, or retail volume, such as, for example, a forecasted demand volume for one or more products at one or more stores of one or more retailers based on the prices of the one or more products.

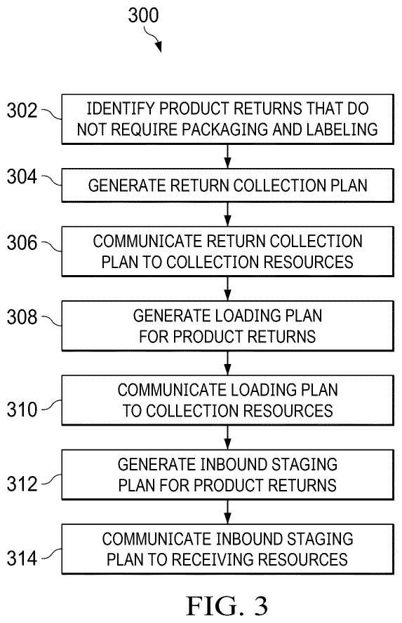

FIG. 3 illustrates method 300 for planning a return of ordered products without packaging and labelling, in accordance with an embodiment. Method 300 may be performed by a zero packaging reverse logistics system, such as zero packaging reverse logistics system 110 of FIG. 1. Method 300 proceeds by one or more activities, which although described in a particular order, may be performed in one or more permutations, combinations, orders, or repetitions, according to particular needs.

At activity 302, returns module 202 of zero packaging reverse logistics system 110 identifies one or more product returns that do not require packaging and labelling. For example, a product that is shipped in a box with packaging to protect the product may not require any additional packaging for reverse logistics. In embodiments, returns module 202 may identify one or more product returns that do not require packaging and labelling based on one or more configurations of a returns pickup vehicle (e.g., when the returns pickup vehicle has cushioned shelves for the one or more product returns), one or more pickup related assets (e.g., a collection resource wearing AR glasses), one or more customer preferences (e.g., that a customer has made an agreement to return products without packaging), and/or any other factor that may deem a product return as not requiring packaging or labelling for reverse logistics.

At activity 304, returns module 202 generates a return collection plan. In embodiments, the return collection plan may indicate one or more product returns to be received and/or picked up which do not require packaging and/or labelling, one or more collection resources to pick up the one or more product returns, and/or associated routing of one or more returns pickup vehicles to pick up one or more product returns, according to a zero packaging reverse logistics approach. As disclosed above, a collection resource may be any resource capable of providing a product return pickup with zero packaging, such as, for example a person, a robot, a drone, or the like. According to embodiments, a returns pickup vehicle may provide one or more capabilities to transport product returns with zero packaging, such as, for example, using padded containers/receptacles and/or refrigeration for transport of zero packaging product returns, and may include one or more capabilities to transport product returns internally and/or externally, such as, for example, with a roof rack, attached bins, and/or backpacks. The return collection plan may instruct the collection resource to scan one or more product returns with a mobile device, such as mobile device 250 of FIG. 2, to verify one or more serial numbers and/or any other inventory identifier of the one or more products. One or more serial numbers of one or more products may be associated with a corresponding one or more product returns, such as, for example, where the serial number is a unique inventory identifier that verifies a product is correct for a product return. In embodiments, mobile device 250 of the collection resource may comprise a barcode scanner (e.g., scanning app 256a of mobile device 250) for scanning one or more product returns and/or augmented-reality (AR) glasses. Embodiments contemplate that AI module 208 of zero packaging reverse logistics system 110 may perform image recognition of one or more products that are being picked up to validate and/or verify the one or more products as correct for one or more product returns. For example, AI module 208 may perform image recognition using a CNN. The return collection plan may further include instructions to use for one or more pickup assets when picking up a product return (e.g., instructions to place a product return in a waterproof bag when performing a pickup in inclement weather), instructions for a location of where to pick up a product return (e.g., from a front porch), instructions for safe and/or proper handling of a product return (e.g., instructions indicating to carefully handle and/or place a fragile product return in a reusable padded container immediately upon pickup), and the like.

At activity 306, user interface module 212 of zero packaging reverse logistics system 110 communicates the return collection plan to one or more collection resources. In embodiments, user interface module 212 may communicate the return collection plan in any format suitable for a collection resource to follow in performing pickup of product returns for reverse logistics. By way of example only and not by way of limitation, user interface module 212 may transmit a return collection plan mobile device 250 of a collection resource and/or to a navigation system of a returns pickup vehicle to provide directions and/or instructions for the collection resource to follow in executing the return collection plan. According to embodiments, mobile device 250 of a collection resource may display the collection plan to the collection resource in any format, such as, for example, using text and/or graphics. The return collection plan may comprise any kind of a schedule and/or list for picking up one or more product returns and any kind of vehicle routing, such as, for example, a list of navigation directions comprising driving directions. In addition, or as an alternative, user interface module 212 may communicate the return collection plan in any format suitable for any combination of human and/or autonomous collection resources. For example, user interface module 212 may communicate the return collection plan in a format suitable for an autonomous returns collection vehicle carrying a human collection resource who picks up one or more product returns, a human resource driving a returns pickup vehicle carrying a robot that picks up one or more product returns, and the like. Further, user interface module 212 may communicate the return collections to mobile device 250 as downloadable apps and/or data for mobile devices 250 to use in displaying the return collections plan, such as, for example, via returns app 256c of mobile device 250.

At activity 308, returns module 202 generates a loading plan for the one or more product returns. In embodiments, the loading plan may provide instructions for one or more collection resources to follow in handling and/or loading one or more product returns according to a zero packaging reverse logistics approach. By way of example only and not by way of limitation, the loading plan may provide instructions for a collection resource to load one or more product returns into one or more particular padded bins for transport and/or into one or more refrigerated compartments. According to embodiments, the loading plan may account for a sequence in which product returns are picked up to provide efficient and/or ease of loading product returns into a returns pickup vehicle, such as, for example, by instructing to load earlier product returns into a returns pickup vehicle so that later product returns may be efficiently and easily loaded.

At activity 310, user interface module 212 communicates the loading plan to one or more collection resources. In embodiments, user interface module 212 may communicate the loading plan in any format suitable for a collection resource to access and follow in loading product returns on a returns pickup vehicle for reverse logistics. By way of example only and not by way of limitation, user interface module 212 may transmit a loading plan to mobile device 250 of a collection resource to provide a loading diagram and instructions for the collection resource to follow in loading one or more product returns on a returns pickup vehicle. Embodiments further contemplate that user interface module 212 may communicate the loading plan in any format suitable for any combination of human and/or autonomous collection resources, such as, for example, an autonomous returns collection vehicle carrying a human collection resource who is instructed how one or more product returns are to be loaded, a human resource driving a returns pickup vehicle carrying a robot that receives electronic instructions for how one or more product returns are to be loaded, and the like. User interface module 212 may further communicate the loading plan to mobile device 250 as downloadable apps and/or data for mobile device 250 to use in displaying the loading plan, such as, for example, returns app 256c. In addition, or as an alternative, user interface module 212 may communicate the loading plan to a resource who is different from the collection resource.

At activity 312, returns module 202 generates an inbound staging plan for the one or more product returns. In embodiments, the inbound staging plan provides instructions for one or more receiving resources to follow in receiving, staging, and/or organizing one or more product returns. The inbound staging plan may comprise any instructions, directions, and/or diagrams for how one or more product returns are to be received and/or organized, such as, for example, in how one or more return products are to be received and/or organized in a receiving facility as part of a reverse logistics process.

At activity 314, user interface module 212 communicates the inbound staging plan to one or more receiving resources. According to embodiments, user interface module 212 communicates the inbound staging plan in any format suitable for a receiving resource to follow in staging and/or organizing one or more received product returns. For example, user interface module 212 may transmit the inbound staging plan mobile device 250 of one or more receiving resources, such as for mobile device 250 to display instructions via returns app 256c for the one or more receiving resources to follow in staging and/or organizing one or more received product returns.

Consider the following example to demonstrate the operation of method 300, in which a customer living in an apartment on the nineteenth floor of a high rise who recently purchased a wristwatch has to return the wristwatch because it arrived with shipping damage. The customer goes online and requests a product return for a 6:00 PM pickup from their home, which returns module 202 identifies as a product return that does not require packaging and labelling at activity 302. At activity 304, returns module 202 generates a collection plan of a collection resource going to the door of the apartment in the high rise and collecting the wristwatch from the customer without additional packaging or labelling, and user interface module 212 transmits the collection plan to a mobile phone of the collection resource at activity 306. At activity 308, returns module 202 generates a loading plan of placing the wristwatch in a padded bin to prevent any additional damage to the wristwatch, and at activity 310, user interface module 212 transmits the loading plan to the mobile phone of the collection resource. At activity 312, returns module 202 generates an inbound staging plan to stage the wristwatch in a location designated for returned products requiring repairs, and user interface transmits the staging plan to the mobile phone of the collection resource at activity 314. Upon the collection resource arriving at the pickup location, the customer hands the wristwatch to the collection resource without any packaging or labelling, which saves the customer time and money from not having to use any packaging materials for returning the wristwatch and saves the retailer time and money from not requiring to unpack the returned wristwatch.

To further demonstrate the operation of method 300, the following additional example is provided, in which a customer decides to return a recently purchased painting. The customer goes online and requests a product return for the painting and opts to drop off the painting at a particular retail location, which returns module 202 identifies as a product return that does not require additional packaging and labeling at activity 302. At activity 304, returns module 202 generates a collection plan of a collection resource receiving the painting from the customer at the drop off location at the retail location, and user interface module 212 transmits the collection plan to a tablet device at the retail location. At activity 308, returns module 202 generates a loading plan of placing the painting in a padded bag upon collection to prevent damage to the painting as a fragile item, and at activity 310, user interface module 212 transmits the loading plan to the tablet device at the retail location. At activity 312, returns module 202 generates an inbound staging plan of placing the painting in a returns area of the retail location, and user interface module 212 transmits the inbound staging plan to the tablet device at the retail location at activity 314. The customer hands the painting to a collection resource without having to package the painting for return, which prevents an inconvenience of having to repackage the painting for return, and benefits the retailer by not having to recycle any packaging material upon receiving the product return and not having to unpack the returned painting.

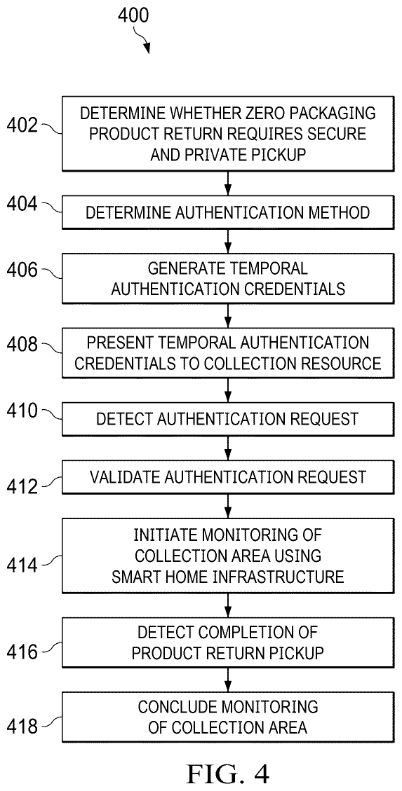

FIG. 4 illustrates method 400 for collecting unpackaged product returns privately and securely, in accordance with an embodiment. Method 400 may be performed by a zero packaging reverse logistics system, such as zero packaging reverse logistics system 110 of FIG. 1. Method 400 proceeds by one or more activities, which although described in a particular order, may be performed in one or more permutations, combinations, orders, or repetitions, according to particular needs.

At activity 402, returns module 202 of zero packaging reverse logistics system 110 determines whether a product return without packaging requires a secure and private pickup. In embodiments, returns module 202 makes the determination based, at least in part, on a product catalog that may provide one or more indications suggesting a requirement for a secure and private pickup (e.g., that the product being returned is a high value item), returns data 222 (e.g., that other similar products have been lost and/or stolen when being returned), customer preferences of customer data 224 (e.g., whether a customer has indicated a preference for private and secure zero packaging product returns), a return location infrastructure (e.g., whether a location has a home automation system, such as home automation system 240 of FIG. 2, with a capability of providing secure access for a collection resource), one or more requirements of a collection resource (e.g., that a returns pickup vehicle is equipped for zero packaging reverse logistics), and/or the like. By way of example only and not by way of limitation, when a business wishes to provide a higher level of service to an important and/or valued customer, returns module 202 may determine based on business configuration settings to provide private and secure zero packaging reverse logistics to the customer.

At activity 404, authentication module 206 of zero packaging reverse logistics system 110 determines an authentication method. In embodiments, the authentication method may be any method used for providing secure access for picking up a product return, such as, for example, by generating a temporary user password for a security system, a temporary code for a keypad for a secure door, using facial recognition of a collection resource, and the like. Authentication module 206 may determine what temporal authentication credentials are necessary for a collection resource to enter a home, secured location, and/or secured space to make a product return pickup according to the particular security infrastructure. In some embodiments, authentication module 206 may communicate with home automation system 240 integrated with zero packaging reverse logistics system 110 to enable the collection resource to be granted access to the pickup location. Embodiments contemplate that home automation system 240 may be a smart home automation system, a building automation and/or security system for one or more product return pickup locations, for example, for a multi-story apartment building, and other like home automation infrastructures. As disclosed above, that collection resource may be a person or any kind of autonomous resource capable of making a product return pickup, such as, for example, a drone, robot, and/or autonomous vehicle.

At activity 406, authentication module 206 generates temporal authentication credentials. According to embodiments, authentication module 206 determines a temporal duration for how long to grant access to the home, secured location, and/or secured space, such as, for example, to give a collection resource the time necessary to make a product return pickup in the home, secured location, and/or secured space. The temporal duration may be a fixed window (e.g., 1:00-3:00 PM on a certain day a product return pickup is scheduled), a duration which elapses beginning with a collection resource arriving at the product return pickup location, a duration which elapses beginning with a granting of access to the product return pickup location, a maximum duration (e.g., a maximum of two minutes), a beginning time commencing with entry of the collection resource into a secured space and/or secured location of a product return pickup location and an ending time determined by the collection resource exiting the secured space and/or secured location of the product return pickup location, and/or the like. For example, when authentication module 206 determines the access to be granted for five minutes for a collection resource to make a product return pickup once being granted access to a secured location, and the collection resource exits the secured location at an elapsed time of three minutes, authentication module 206 terminates the access upon the collection resource exiting the secured location. According to embodiments, authentication module 206 may generate a one-time-password as the credentials for entry through a password enabled door, a picture of a collection resource for entry through face-recognition at the pickup location, or a unique user-id/password.

At activity 408, user interface module 212 of zero packaging reverse logistics system 110 presents the generated temporal authentication credentials to the collection resource. As described in greater detail above, the temporal authentication credentials may comprise any kind of electronic, physical, and/or biometric credential capable of granting access to a product return pickup location, such as, for example, a key code for entry on a keypad to unlock a door, a wireless key card to unlock a door, a security token transmitted via an interface (e.g., USB, near-field communication, RFID, Bluetooth, etc.), any kind of biometric identifier used for granting access (e.g., facial recognition, fingerprint scan, and/or iris scan), any kind of password token (e.g., static, synchronous dynamic, asynchronous, or challenge-response). As discussed in above, the authentication credentials may be associated with a temporal aspect and/or attribute. For example, the temporal authentication credentials may be a token and/or code transmitted to mobile device 250 of a collection resource such that the collection resource may use the token and/or code to be granted access to the product return pickup location for a predetermined time limit, after which the token and/or code expires. In another example, the temporal authentication credentials may be a physical object, such as a key card or an electronic token on a flash drive, which a collection resource may use to access the product return pickup location according to one or more temporal attributes.

At activity 410, authentication module 246 of home automation system 240 detects an authentication request. Embodiments contemplate that the authentication request may be detected in any way, such as, for example, electronically, physically, and/or using biometrics. For example, authentication app 256e of mobile device 250 of the collection resource may transmit an electronic code and/or token to authentication module 246 be granted access, where the transmission is detected as an authentication request. In other examples, an authentication request may be detected when credentials comprising an alphanumeric code are entered on a keypad, when credentials are submitted using an electronic key card to unlock a door and/or gate, or when biometric credentials such as a fingerprint scan, an iris scan, and/or a facial recognition scan are submitted by the collection resource.

At activity 412, authentication module 246 validates the authentication request. In embodiments, authentication module 246 validates the request against the generated temporal authentication credentials, such as by associating temporal factors with an entered authentication credential. For example, when a particular key code is entered at a door, authentication module 246 may recognize that the entered authentication credential is associated with a temporal factor granting entry for a limited period of time. According to embodiments, the temporal factors may comprise one or more factors that determine a time and/or duration for granted access to the collection resource, such as granting access to a collection resource for a short period of time to access a location to pick up a product for a return. Embodiments further contemplate that the authentication request may be validated by one or more external systems, according to particular needs.

At activity 414, authentication module 246 initiates monitoring of the collection area using a smart home infrastructure. In embodiments, the monitoring may comprise camera surveillance of the collection resource for a time duration that the collection resource is granted access to make the product return pickup, or any kind of monitoring and/or tracking of a collection resource before, during, and/or after the collection resource makes a product return pickup at the pickup location. For example, the monitoring may comprise one or more camera feeds that track and/or record the collection resource as they enter a home, pick up a product for a return, and leave the home. Embodiments contemplate that the monitoring may be performed by any kind of electronic sensor capable of detecting a presence and/or movement of a collection resource, such as, for example, one or more motion detectors.

At activity 416, returns module 202 detects completion of the product return pickup. In embodiments, returns module 202 may receive data from scanning app 256a, imaging app 256b, navigation app 256d, and/or authentication app 256e of mobile device 250 of the collection resource, authentication module 246, or one or more other streams of data, such as security camera footage of a smart home infrastructure indicating that the pickup is complete and the collection resource has exited the collection area. Embodiments contemplate that returns module 202 may associate other aspects with completion of a product return pickup, according to business needs. Returns module 202 may further provide a notification indicating completion of the product return pickup, for example, by emailing, texting, and/or sending pictures to a customer via user interface module 212.

At activity 418, authentication module 246 concludes the monitoring of the collection area. In embodiments, authentication module 246 may stop the monitoring once the collection resource leaves the secured location and/or secured space of the product return pickup location. For example, when a collection resource leaves a product return pickup location via using an electronic keycard through a locked door, authentication module 246 may disable the monitoring. Authentication module 246 may, in cases where a temporal factor is exceeded for a pickup, notify the customer via, for example, a message and/or email on their mobile phone. By way of example only and not by way of limitation, when a collection resource has a maximum of five minutes to make a product return pickup within a secured location and/or secured space and has not made the product return pickup and exited the secured location and/or secured space within the five minute limit, authentication module 246 may notify the customer to ensure security of the product return pickup location. In another example, when a collection resource has been granted access to a first floor lobby of a large high rise apartment building and, because of the complexity of the first floor layout, cannot find the security office in the allotted time specified by the temporal factor, authentication module 246 may send a notification to the customer to provide the customer with an opportunity to go to the first floor to assist the collection resource in making the pickup of the product return. In this example, authentication module 246 provides for a robust and fault-tolerant way to ensure collection of a product return and provide security for the collection location.

Consider the following example to demonstrate the operation of method 600, in which a customer who recently purchased a wristwatch has to return the wristwatch because it arrived with shipping damage. The customer goes online and requests a product return for a 6:00 PM pickup from their home and keeps the watch in the foyer area of their home for ease of handover when it is picked up. On the day of the pickup, the customer is delayed at their office for an urgent meeting and cannot be at home in time for the 6:00 PM pickup, so the customer requests a secure in-home pickup, which returns module 202 determines as a zero packaging product return requiring secure and private pickup at activity 402. At activity 404, authentication module 206 determines to use an authentication method of a temporary password for the front door, according to the customer preferences. At activity 406, authentication module 206 generates the temporary password with a validity between 5:29 and 5:31 PM and informs the collection resource assigned to the pickup of the temporary password and associated time of validity at activity 408. At 5:29 PM, authentication module 246 directs home automation system 240 to begin video recording of the entry and foyer areas of the home at activity 414. At 5:30 PM, authentication module 246 detects an authentication request as the collection resource arrives at the home and uses the temporary password to access the home at activity 410, and validates the authentication request against the generate temporal authentication credentials received from authentication module 206 at activity 412. Upon the collection resource picking up the wristwatch from a table in the foyer and leaving by the front door, returns module 202 detects the completion of the product return pickup at activity 416, and at activity 418, authentication module 246 concludes the monitoring of the collection by stopping the video recording and disabling the temporary password.

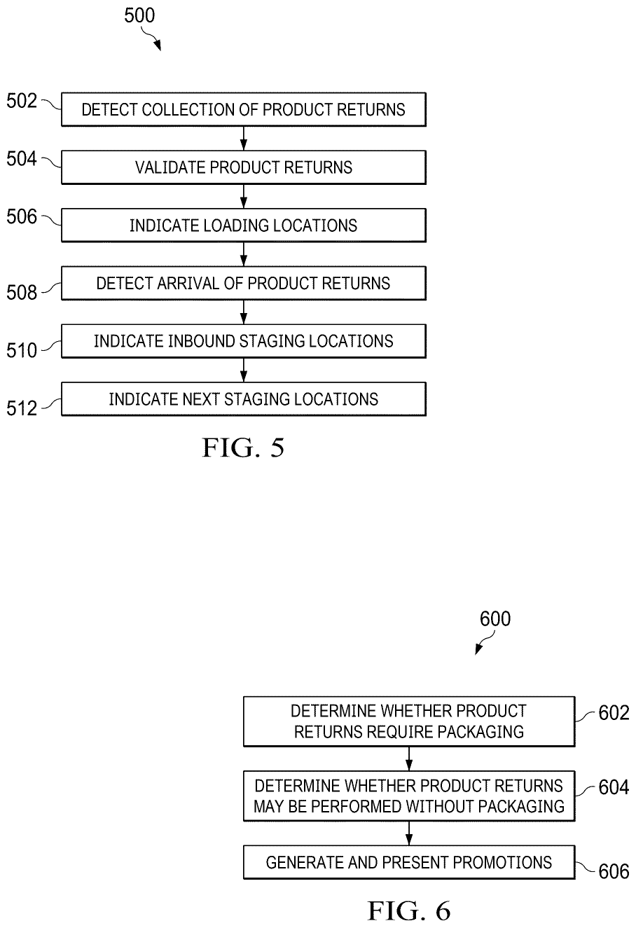

FIG. 5 illustrates method 500 for facilitating a return of one or more products without packaging, in accordance with an embodiment. Method 500 may be performed by a zero packaging reverse logistics system, such as zero packaging reverse logistics system 110 of FIG. 1. Method 500 proceeds by one or more activities, which although described in a particular order, may be performed in one or more permutations, combinations, orders, or repetitions, according to particular needs.

At activity 502, returns module 202 of zero packaging reverse logistics system 110 detects a collection of one or more product returns. In embodiments, returns module 202 detects the collection of one or more product returns based on receiving a scan of the one or more product returns by scanning app 256a of mobile device 250 of a collection resource to determine a product identifier (e.g., an inventory identifier),based on imaging of a product being picked up for return by imaging app 256b of mobile device 250 of a collection resource to identify the product return (e.g., comparing one or more return product images to one or more identified product images from a catalog), or other data indicating a collection of one or more product returns, such as, for example, security monitoring data received from home automation system 240 of a pickup location.

At activity 504, returns module 202 validates the one or more product returns. According to embodiments, returns module 202 validates the one or more product returns based on an inventory attribute, such as a product serial number, by classifying and/or recognizing one or more product attributes from one or more images of the product that provide one or more indications that a product being returned is the correct product, and by other like sources of validation that the one or more detected product returns are correct.

At activity 506, returns module 202 indicates one or more loading locations to a collection resource. In embodiments, returns module 202 indicates the one or more loading locations on a returns pickup vehicle for the collection resource, such as, for example, within one or more padded bins, shelves, and/or on a roof rack. The one or more loading locations may comprise a refrigerated space and/or compartment in a returns pickup vehicle, one or more internal and/or external racks for transporting one or more product returns, a location on or within a collection resource (e.g., within a backpack of a collection resource), one or more locations on a drone, an autonomous vehicle, and/or a robot, and/or the like. According to embodiments, user interface module 212 of zero packaging reverse logistics system 110 may present the one or more indicated loading locations using any kind of device, such as AR glasses, a smartphone, and/or a voice assistant.

At activity 508, returns module 202 detects an arrival of the one or more product returns. For example, returns module 202 may detect the arrival of the one or more product returns via a navigation system associated with a returns pickup vehicle (e.g., via navigation app 256d of mobile device 250), one or more scans received from scanning app 256a of mobile device 250 of a receiving resource, imaging of the one or more product returns received from imaging app 256b of mobile device 250 of a receiving resource (e.g., to compare one or more images of the one or more product returns to one or more other images, such as catalog images, to identify the product being returned), interaction with a checklist displayed via mobile device 250 of a receiving to mark the arrival of the one or more product returns, one or more camera feeds at a loading dock of a receiving facility, scanning the one or more product returns via one or more RFID scanners, and/or the like.

At activity 510, returns module 202 indicates one or more inbound staging locations to a receiving resource. According to embodiments, returns module 202 indicates the one or more inbound staging locations via presenting graphical, textual, audio, and/or voice instructions for the receiving resource to follow in staging one or more received product returns, or any other one or more steps in a reverse logistics process for product returns. For example, returns module 202 may utilize user interface module 212 to present the indication of the one or more inbound staging locations via mobile device 250 (e.g., by displaying the instructions on a smartphone of the receiving resource), via AR glasses, via a voice assistant, and/or the like. Embodiments contemplate that the receiving resource may comprise any resource capable of staging and/or organizing one or more product returns, such as, for example, a human resource, a robot, an automated machine, an autonomous vehicle (e.g., an automated guided vehicle), and the like.

At activity 512, returns module 202 indicates one or more next staging locations to the receiving resource. According to embodiments, returns module 202 indicates the one or more next staging locations via presenting graphical, textual, audio, and/or voice instructions and/or directions for the receiving resource to follow to perform further staging, organizing, and/or processing of one or more received product returns. As disclosed above, the receiving resource may comprise any resource capable of staging and/or organizing one or more product returns, such as, for example, a human resource, a robot, an automated machine, an autonomous vehicle, and the like. In embodiments, returns module 202 utilizes user interface module 212 to present the indication of the one or more next staging locations via a mobile device, AR glasses, voice assistant, and/or the like. Embodiments contemplate that returns module 202 may indicate the one or more next staging locations as part of any reverse logistics process and/or workflow, such as, for example, to provide one or more steps comprising providing an inspection, disposition, repair, remanufacture, service, and/or resale of one or more product returns. By way of example only and not by way of limitation, a receiving resource may wear AR glasses that provide an indication of where one or more product returns are to be staged, and how the one or more product returns are to be organized, such as by having the one or more product returns oriented a particular way so to be easily scanned and/or imaged. Further in this example, the AR glasses worn by a receiving resource may provide instructions and/or directions for the receiving resource to follow in performing any of one or more steps in a reverse logistics process, such as, for example, inspection, disposition, repair and/or remanufacture, service and/or resale, and the like.

FIG. 6 illustrates method 600 for facilitating a return of one or more products without packaging with a promotion, in accordance with an embodiment. Method 600 may be performed by a zero packaging reverse logistics system, such as zero packaging reverse logistics system 110 of FIG. 1. Method 600 proceeds by one or more activities, which although described in a particular order, may be performed in one or more permutations, combinations, orders, or repetitions, according to particular needs.

At activity 602, returns module 202 of zero packaging reverse logistics system 110 determines whether one or more product returns require packaging. In embodiments, returns module 202 makes the determination based, at least in part, on a product catalog and/or one or more descriptions of one or more products corresponding to the one or more product returns. By way of example only and not by way of limitation, a product catalog and/or one or more product descriptions may specify or otherwise indicate that the one or more product returns may not require packaging for carrying and/or transporting the one or more product returns. Embodiments contemplate that the one or more product returns may require one or more types of reusable collection assets and/or containers for the one or more products to be returned without packaging. Such reusable collection assets may comprise any type of asset that may be used to carry and/or transport one or more product returns. By way of example only and not by way of limitation, one or more reusable collection assets may comprise a bag and/or container for carrying and/or transporting one or more clothing items, a box and/or a bin that may provide support and/or protection for carrying and/or transporting one or more fragile items, a box, bin, or pallet with one or more fixtures for carrying and/or transporting one or more heavy items, and/or any other type of reusable collection asset necessary for the carrying and/or transporting of the one or more product returns. Embodiments further contemplate any kind of reusable collection asset that may, after one or more product returns are collected, transported, and received into a reverse logistics facility, be used to convey and/or carry the one or more product returns through one or more steps of a reverse logistics process. For example, a garment bag with a hook, which contains one or more returned clothing items, may have one or more features that facilitate one or more steps, such as inspection and/or disposition, in a reverse logistics process.

At activity 604, returns module 202 determines whether one or more product returns may be performed without packaging. In embodiments, returns module 202 makes the determination based on a customer profile, other customer data 224, and order preferences. For example, a customer profile may specify that a customer agrees to product returns without using packaging. In another example, a customer profile may indicate one or more attributes and/or criteria expressing the customer preference for handling product returns without using packaging, such as by specifying that zero packaging reverse logistics be applied to certain kinds of products, be applied for pickups at particular times and/or dates, and/or the like. According to embodiments, customer preference data may specify a preference for or against zero packaging reverse logistics, such as, for example, that zero packaging reverse logistics be applied to certain types of product returns and not be applied to other types of product returns.

At activity 606, promotion module 214 of zero packaging reverse logistics system 110 generates and presents one or more personalized promotions. In embodiments, promotion module 214 generates the one or more personalized promotions based on customer data 224 (e.g., a customer having a demonstrated history of being environmentally conscious and thus would likely agree to zero packaging reverse logistics when given a promotion), business commitments (e.g., based on a company commitment to sustainability as part of corporate stewardship of the environment) and the like. Business commitments may comprise one or more corporate goals for sustainability, carbon footprint, and/or cost reduction associated with zero packaging reverse logistics. According to embodiments, the one or more personalized promotions may reward a customer for agreeing to zero packaging reverse logistics. For example, the promotion may include a discount of a certain percentage or a certain amount for a future order when a customer agrees to zero packaging reverse logistics for one or more product returns. As disclosed above, promotion module 214 may personalize the promotion for a particular customer. In addition, or as an alternative, promotion module 214 may generate promotions to reward and/or thank customers for agreeing to zero packaging reverse logistics for one or more product returns, such as, for example, to reward and/or thank customers for participating in an environmentally responsive program and to improve company goodwill by communicating the commitment towards sustainable practices by offering zero packaging reverse logistics. In embodiments, the promotion may be a part of a customer loyalty program to, for example, offer loyalty program reward points or other loyalty program incentives. Embodiments contemplate that the personalized promotion may be accompanied by one or more messages provided by NLP module 210 of zero packaging reverse logistics system 110 and/or graphics to communicate to the customer one or more benefits resulting from participating in zero packaging reverse logistics, such as, for example, environmental consciousness, sustainability, reduced inconvenience in returning a product, and the like.

Reference in the foregoing specification to “one embodiment”, “an embodiment”, or “some embodiments” means that a particular feature, structure, or characteristic described in connection with the embodiment is included in at least one embodiment of the invention. The appearances of the phrase “in one embodiment” in various places in the specification are not necessarily all referring to the same embodiment.

While the exemplary embodiments have been illustrated and described, it will be understood that various changes and modifications to the foregoing embodiments may become apparent to those skilled in the art without departing from the spirit and scope of the present invention.

What is claimed is:

1. A system for planning a return of ordered products without packaging and labelling, comprising:
a returns pickup vehicle configured to transport items with zero packaging;
a computer, comprising a processor and memory, and configured to:
identify one or more product returns that do not require packaging and labelling;
generate a return collection plan indicating the one or more product returns to be received and picked up, wherein the one or more product returns do not require packaging for transport by the returns pickup vehicle;
communicate the return collection plan to one or more collection resources;
generate a loading plan for the one or more product returns;
communicate the loading plan for a collection resource to access and follow in loading the one or more product returns on the returns pickup vehicle;
generate an inbound staging plan for the one or more product returns; and
communicate the inbound staging plan to one or more receiving resources.

2. The system of claim 1, wherein the one or more product returns that do not require packaging and labelling are identified based on one or more configurations of the returns pickup vehicle.

3. The system of claim 1, wherein the computer is further configured to:
perform image recognition of the one or more product returns to verify the one or more product returns.

4. The system of claim 1, wherein the computer is further configured to:
receive a scan of the one or more product returns performed via a scanning app of a mobile device to verify one or more serial numbers of the one or more product returns.

5. The system of claim 1, wherein the returns pickup vehicle comprises padded containers and receptacles.

6. The system of claim 1, wherein the returns pickup vehicle comprises a drone or an autonomous returns collection vehicle.

7. The system of claim 1, wherein the computer is further configured to:
provide temporal authentication credentials for access for making pickup of the one or more product returns.

8. A computer-implemented method for planning a return of ordered products without packaging and labelling, comprising:
providing a returns pickup vehicle configured to transport items with zero packaging;
identifying, by a computer comprising a processor and memory, one or more product returns that do not require packaging and labelling;
generating, by the computer, a return collection plan indicating the one or more product returns to be received and picked up, wherein the one or more product returns do not require packaging for transport by the returns pickup vehicle;
communicating, by the computer, the return collection plan to one or more collection resources;
generating, by the computer, a loading plan for the one or more product returns;
communicating, by the computer, the loading plan for a collection resource to access and follow in loading the one or more product returns on the returns pickup vehicle;
generating, by the computer, an inbound staging plan for the one or more product returns; and
communicating, by the computer, the inbound staging plan to one or more receiving resources.

9. The computer-implemented method of claim 8, wherein the one or more product returns that do not require packaging and labelling are identified based on one or more configurations of the returns pickup vehicle.

10. The computer-implemented method of claim 8, further comprising:
performing, by the computer, image recognition of the one or more product returns to verify the one or more product returns.

11. The computer-implemented method of claim 8, further comprising:
receiving, by the computer, a scan of the one or more product returns performed via a scanning app of a mobile device to verify one or more serial numbers of the one or more product returns.

12. The computer-implemented method of claim 8, wherein the returns pickup vehicle comprises padded containers and receptacles.

13. The computer-implemented method of claim 8, wherein the returns pickup vehicle comprises a drone or an autonomous returns collection vehicle.

14. The computer-implemented method of claim 8, further comprising:
providing, by the computer, temporal authentication credentials for access for making pickup of the one or more product returns.

15. A non-transitory computer-readable storage medium embodied with software for planning a return of ordered products without packaging and labelling, the software when executed by a computer is configured to:
identify one or more product returns that do not require packaging and labelling;
generate a return collection plan indicating the one or more product returns to be received and picked up, wherein the one or more product returns do not require packaging for transport by the returns pickup vehicle;
communicate the return collection plan to one or more collection resources;
generate a loading plan for the one or more product returns;
communicate the loading plan for a collection resource to access and follow in loading the one or more product returns on the returns pickup vehicle;
generate an inbound staging plan for the one or more product returns; and
communicate the inbound staging plan to one or more receiving resources.

16. The non-transitory computer-readable storage medium of claim 15, wherein the one or more product returns that do not require packaging and labelling are identified based on one or more configurations of the returns pickup vehicle.

17. The non-transitory computer-readable storage medium of claim 15, wherein the software when executed is further configured to:
perform image recognition of the one or more product returns to verify the one or more product returns.

18. The non-transitory computer-readable storage medium of claim 15, wherein the software when executed is further configured to:
receive a scan of the one or more product returns performed via a scanning app of a mobile device to verify one or more serial numbers of the one or more product returns.

19. The non-transitory computer-readable storage medium of claim 15, wherein the returns pickup vehicle comprises padded containers and receptacles.

20. The non-transitory computer-readable storage medium of claim 15, wherein the returns pickup vehicle comprises a drone or an autonomous returns collection vehicle.
